(19) United States
(12) Patent Application Publication
(10) Pub. No.: US 2002/0172640 A1
(43) Pub. Date: Nov. 21, 2002

(54) Process for producing chlorine

(75) Inventors: Takuo Hibi, Chiba (JP); Yoshiaki Ito, Chiba (JP); Hiroaki Abekawa, Chiba (JP); Masaru Ishino, Chiba (JP); Toshio Nakayama, Chiba (JP)

Correspondence Address: SUGHRUE MION, PLC, 2100 Pennsylvania Avenue, NW, Washington, DC, 20037-3213, US

(73) Assignee: SUMITOMO CHEMICAL COMPANY, LIMITED

(21) Appl. No.: 10/098,434

(22) Filed: Mar. 18, 2002

Related U.S. Application Data
(63) Continuation of application No. 08/961,239, filed on Oct. 30, 1997, now abandoned.

(30) Foreign Application Priority Data
Oct. 31, 1996 (JP) 8-290092
Nov. 5, 1996 (JP) 8-292465
Nov. 5, 1996 (JP) 8-292463
Nov. 8, 1996 (JP) 8-296305
Nov. 14, 1996 (JP) 8-302656
Jan. 23, 1997 (JP) 9-010608
Apr. 10, 1997 (JP) 9-092042

(51) Int. Cl. C01B 7/00

(52) U.S. Cl. 423/502

(57) ABSTRACT

A process for producing chlorine by oxidizing hydrogen chloride with oxygen in the presence of a supported ruthenium oxide catalyst or a ruthenium mixed oxide catalyst. The content of ruthenium oxide is from 0.1 to 20% by weight and the ruthenium oxide has a mean particle diameter of from 1.0 to 10.0 nm.

### FIELD OF THE INVENTION

The present invention relates toga process for producing chlorine. More particularly, it relates to a process for producing chlorine, which comprises oxidizing hydrogen chloride, said process being capable of producing chlorine at a lower reaction temperature using a catalyst having high activity in a smaller amount.

### BACKGROUND OF THE INVENTION

It is known that chlorine is useful as a raw material of vinyl chloride, phosgene, etc., and can be produced by oxidizing hydrogen chloride. For example, the Deacon reaction using a Cu catalyst is well known. For example, a process of oxidizing hydrogen chloride with a catalyst containing a ruthenium compound is described in British Patent No. 1,046,313 and, there is also described that ruthenium (III) chloride is particularly effective among the ruthenium compounds. Furthermore, a process of supporting a ruthenium compound on a carrier is also described and, as the carrier, silica gel, alumina, pumice stone and ceramic material are exemplified. As the Example, a ruthenium chloride catalyst supported on silica is exemplified. However, a test was conducted using a catalyst prepared by using a process of preparing a supported ruthenium (III) chloride on silica described in said patent. As a result, the ruthenium compound as a catalyst component is drastically evaporated and it was disadvantageous for industrial use. For example, a process of oxidizing hydrogen chloride with a chromium oxide catalyst is described in EP0184413A2. However, a process which has hitherto been known had a problem that the activity of the catalyst is insufficient and high reaction temperature is required.

When the activity of the catalyst is low, a higher reaction temperature is required but the reaction of oxidizing hydrogen chloride with oxygen to produce chlorine is an equilibrium reaction. When the reaction temperature is high, it becomes disadvantageous in view of equilibrium and the equilibrium conversion of hydrogen chloride decrease. Therefore, when the catalyst has high activity, the reaction temperature can be decreased and, therefore, the reaction becomes advantageous in view of equilibrium and higher conversion of hydrogen chloride can be obtained. In case of the high reaction temperature, the activity is lowered by volatilization of the catalyst component. Also in this point of view, it has been required to develop a catalyst which can be used at low temperature.

Both high activity per unit weight of catalyst and high activity per unit weight of ruthenium contained in the catalyst are required to the catalyst, industrially. Since high activity per unit weight of ruthenium contained in the catalyst can reduces the amount of ruthenium contained in the catalyst, it becomes advantageous in view of cost. It is possible to select the reaction condition which is more advantageous in view of equilibrium by conducting the reaction at a lower temperature using a catalyst having high activity. It is preferred to conduct the reaction at a lower temperature in view of stability of the catalyst.

### SUMMARY OF THE INVENTION

Under these circumstances, an object of the present invention is to provide a process for producing chlorine, which comprises oxidizing hydrogen chloride, said process being capable of producing chlorine at a lower reaction temperature using a catalyst having high activity in a smaller amount.

That is, the present invention provides a process for producing chlorine which comprises oxidizing hydrogen chloride with oxygen by using a supported ruthenium oxide catalyst or a ruthenium mixed oxide type catalyst wherein a content of ruthenium oxide is from 0.1 to 20% by weight and a mean particle diameter of ruthenium oxide is from 1.0 to 10.0 nm;

a process for producing chlorine which comprises oxidizing hydrogen chloride with oxygen by using a supported ruthenium oxide catalyst wherein a content of ruthenium oxide is from 0.5 to 20% by weight;

a process for producing chlorine which comprises oxidizing hydrogen chloride with oxygen by using a supported ruthenium oxide catalyst obtained by oxidizing a supported metal ruthenium catalyst in a gas containing oxygen at not more than 500° C.;

a process for producing chlorine which comprises oxidizing hydrogen chloride with oxygen by using a supported ruthenium oxide catalyst obtained by calcining a supported metal ruthenium catalyst in a gas containing oxygen in the presence of an alkali metal salt;

a process for producing chlorine which comprises oxidizing hydrogen chloride with oxygen by using a supported ruthenium oxide catalyst obtained by supporting with a spherical carrier having a particle size of 10 to 500 μm;

a process for producing chlorine which comprises oxidizing hydrogen chloride with oxygen by using a catalyst obtained by coating an inert carrier with a ruthenium oxide catalyst, or a catalyst obtained by extruding a ruthenium oxide catalyst; and

a process for producing chlorine which comprises oxidizing hydrogen chloride with oxygen by using a ruthenium catalyst in an aqueous phase.

### DETAILED DESCRIPTION OF THE INVENTION

In the present invention, the ruthenium catalyst wherein the mean particle diameter of ruthenium oxide is from 1.0 to 10.0 nm is a catalyst wherein the content of ruthenium oxide is from 0.1 to 20% by weight, preferably from 0.5 to 20% by weight, more preferably from 0.5 to 15% by weight, most preferably from 1 to 15% by weight, including a mixed oxide type catalyst of ruthenium and other metal, and a supported ruthenium oxide catalyst prepared by supporting ruthenium oxide on a carrier. In general, it is used in the form of being supported on the carrier, industrially.

Examples of the carrier include oxides and mixed oxides of elements, such as titanium oxide, alumina, zirconium oxide, silica, titanium mixed oxide, zirconium mixed oxide, aluminum mixed oxide, silicon mixed oxide and the like. Preferable carriers are titanium oxide, alumina, zirconium oxide and silica, and more preferable carrier is titanium oxide. The weight ratio of ruthenium oxide to the carrier is normally within the range from 0.1/99.9 to 20.0/80.0, preferably from 0.5/99.5 to 15.0/85.0, more preferably from 1.0/99.0 to 15.0/85.0. When the ratio of ruthenium oxide is too low, the activity is lowered sometimes. On the other hand, when the ratio of ruthenium oxide is too high, the price of the catalyst becomes high sometimes. Examples of the ruthenium oxide supported include ruthenium dioxide, ruthenium hydroxide and the like.

Incidentally, a third component other than ruthenium can also be added, and examples of the third component include noble metal compound other than ruthenium (e.g. palladium compound, etc.), rare earth compound, copper compound, chromium compound, nickel compound, alkali metal compound, alkali earth metal compound, manganese compound, tantalum compound, tin compound, vanadium compound and the like. The amount of the third component added is normally from 0.1 to 10% by weight based on the carrier.

The ruthenium mixed oxide type catalyst is obtained by chemically-mixing at least one oxide (e.g. titanium oxide, zirconium oxide, alumina, silica, vanadium oxide, boron oxide, chromium oxide, niobium oxide, hafnium oxide, tantalum oxide, tungsten oxide, etc.) with ruthenium oxide, but the compound used for production of ruthenium mixed oxide is not limited to the above compounds.

Examples of the process of preparing the mixed oxide catalyst of ruthenium and the other metal, wherein the mean particle diameter of ruthenium oxide is from 1.0 to 10.0 nm, will be described below. Examples of the process for production of the ruthenium mixed oxide from ruthenium oxide include a process of adding those prepared by hydrolyzing a ruthenium compound.(e.g. ruthenium chloride, etc.) dissolved in water with an alkali (e.g. alkalimetal hydroxide, ammonia water, etc.) to those prepared by hydrolyzing a chloride, an oxychloride, a nitrate, an oxynitrate, an alkali salt of oxy-acid or a sulfate of titanium, etc. dissolved in water with an alkali (e.g. alkali metal hydroxide, ammonia water, etc.) or those prepared by hydrolyzing an alkoxide with an acid, followed by sufficient mixing, filtration, washing and further calcination in air. The calcining temperature is normally from 300 to 500° C. Preferable examples of the oxide used for production of the ruthenium mixed oxide include titanium oxide, zirconium oxide, alumina, silica, titanium mixed oxide, zirconium mixed oxide, aluminum mixed oxide and silicon mixed oxide.

The ruthenium mixed oxide may also be supported on the carrier. Examples of the process of supporting the ruthenium mixed oxide on a carrier include a process of impregnating a carrier with a chloride or a nitrate of titanium, etc. and a ruthenium compound (e.g. ruthenium chloride, etc.)., followed by calcination in air. As the carrier, the same carrier as that described in the item of the supported ruthenium oxide catalyst can be used. The amount of ruthenium oxide contained in the ruthenium mixed oxide is normally from 0.1 to 20% by weight, preferably from 0.5 to 20% by weight, more preferably from 0.5 to 15% by weight, most preferably from 1 to 15% by weight. Incidentally, the third component can also be added. As the third component, there can be used the same third component as that described in the item of the supported ruthenium oxide.

Examples of the process for preparation of the ruthenium oxide catalyst, wherein the mean particle diameter of ruthenium oxide is from 1.0 to 10.0 nm, will be described below. Ruthenium chloride (RuCl₃.nH₂O) is dissolved in an aqueous dilute hydrochloric acid solution to prepare an aqueous ruthenium chloride-hydrochloric-acid solution. After the aqueous solution is allowed to stand for 1 day, a carrier powder such as titanium oxide is suspended in the aqueous solution and an aqueous alkali solution of an alkali metal hydroxide is added dropwise with stirring, thereby hydrolyzing ruthenium chloride with controlling to the predetermined pH, resulting in precipitation-supporting on the carrier. Furthermore, the suspension is heated with controlling the pH to accelerate the hydrolysis. The pH is normally from 3 to 7 and the heating temperature is normally from 50 to 70° C. The heating time is normally from 1 to 10 hours. Then, the suspension is heated to evaporate to dryness. The temperature for evaporation to dryness is normally from 40 to 150° C. (outer temperature) and the suspension can also be vacuum-dried. The suspension can also be evaporated to dryness, after it was allowed to stand and the supernatant is removed by decantation. The resultant is subjected to primary calcination at 100 to 200° C. for 2 to 24 hours, and then subjected to second calcination at 300 to 450° C. for 2 to 24 hours. Then, the alkali metal chloride contained in the catalyst is removed by washing with water, followed by drying at about 100° C. Examples of the atmosphere of the above preparation include air.

As the process for preparation of the ruthenium oxide catalyst, wherein the mean particle diameter of ruthenium oxide is from 1.0 to 10.0 nm, the following process can be used, in addition to the above preparation process.

That is, there can be used a process of impregnating a supported metal ruthenium catalyst with an aqueous solution of an alkali metal salt, drying the catalyst, calcining the catalyst in a gas containing oxygen, followed by washing with water and further drying. As the supported metal ruthenium catalyst, a catalyst wherein the particle size of metal ruthenium particles is small is preferable. Examples of the process for preparation of the supported metal ruthenium catalyst include a process of supporting ruthenium chloride on the above described carrier and reducing it with hydrogen, and a process of supporting ruthenium chloride on the above described carrier, forming a ruthenium hydroxide on the carrier due to alkali hydrolysis and reducing it with hydrogen. Incidentally, there may be used a commercially available supported metal ruthenium catalyst wherein the particle size of metal ruthenium particles is small. Examples of the commercially available supported metal ruthenium catalyst, wherein the particle size of metal ruthenium particles is small, include commercially available spherical (2% by weight) supported metal ruthenium catalyst on titanium oxide and spherical (5% by weight) supported metal ruthenium catalyst on titanium oxide (N.E. Chemcat Co.). The molar ratio of the alkali metal salt to ruthenium is preferably from 0.01 to 10, more preferably from 0.1 to 5. The calcining temperature is preferably from 280 to 450° C. The calcining time is normally from 30 minutes to 10 hours. The alkalimetal salt added is removed by washing with water, but may be remained unless the catalytic activity of this catalyst is damaged.

The above ruthenium oxide catalyst, wherein the mean particle diameter of ruthenium oxide is from 1.0 to 10.0 nm, can also be prepared by the preparation process described below in the item of the precipitation-supported ruthenium oxide catalyst, and can also be prepared by the preparation process described below in the item of the supported ruthenium oxide catalyst obtained by calcining the supported metal ruthenium in a gas containing oxygen in the presence of an alkali metal salt.

Regarding the supported ruthenium oxide catalyst prepared in the above examples, ruthenium oxide having a mean particle diameter of 1.0 to 10.0 is supported on the carrier and the particle size of ruthenium oxide can be measured by a transmission electron microscope. The mean particle diameter refers to a statistic average value of the observed ruthenium oxide particle diameter, but can be substituted with an arithmetic average of the particle diameter of a lot of particles among the observed particles.

It is also possible to measure the particle diameter of the metal ruthenium by absorption of carbon monoxide after reducing the supported ruthenium oxide catalyst. The measured value can be used as substitution as far as a large error is not recognized between the measured value and the value measured by the transmission electron microscope.

When the mean particle diameter exceeds 10.0 nm, the catalytic activity is lowered. Therefore, it is preferably within the range from 1.0 to 10.0 nm, more preferably from 1.0 to 6.0 nm. Within the above range, the proportion of the ruthenium oxide particles having the mean particle diameter of 1.0 to 10.0 nm is preferably not less than 80%. Within the above range, the catalyst having smaller mean particle diameter is more preferable because of higher activity.

It can be confirmed by X-ray diffraction and XPS (X-ray photoelectron spectroscopy, etc.) that the ruthenium compound contained in the catalyst is ruthenium oxide.

In the present invention, it is also possible to use a supported ruthenium oxide catalyst wherein the content of ruthenium oxide is from 0.5 to 20% by weight, preferably 0.5 to 15% by weight, more preferably 1 to 15% by weight. When the content of ruthenium oxide is larger than 20% by weight, the activity per unit weight of ruthenium contained is lowered. On the other hand, when it is smaller than 0.5% by weight, the activity per unit weight of ruthenium is also lowered. Examples of ruthenium oxide supported include ruthenium oxide such as ruthenium dioxide, ruthenium hydroxide and the like.

Examples of the supporting process include various processes. For example, the process for preparation of the precipitation-supported ruthenium oxide catalyst is preferable. That is, a carrier is suspended in a solution prepared by dissolving a ruthenium compound (e.g. ruthenium chloride, etc.), adding an alkali to hydrolyze the ruthenium compound to form ruthenium hydroxide, precipitation-supporting ruthenium hydroxide on a carrier, followed by oxidation to form ruthenium oxide. Preferable ruthenium compound is ruthenium chloride. In this case, the oxidation is conducted by a process of using aqueous hydrogen peroxide or oxygen. When calcining using air, the calcining temperature is preferably from 300 to 400° C.

Examples of the carrier of the supported ruthenium oxide catalyst include oxides and mixed oxides of elements, such as titanium oxide, alumina, zirconium oxide, silica, titanium mixed oxide, zirconium mixed oxide, aluminum mixed oxide, silicon mixed oxide and the like. Preferable carriers are titanium oxide, alumina, zirconium oxide and silica, and more preferable carrier is titanium oxide. The weight ratio of ruthenium oxide to the carrier is normally within the range from 0.5/99.5 to 20/80, preferably from 1.0/99.0 to 15/85.

When the ratio of ruthenium oxide is too low, the activity is lowered sometimes. On the other hand, when the ratio of ruthenium oxide is too high, the price of the catalyst becomes high sometimes. Incidentally, a third component other than ruthenium can also be added, and examples of the third component include palladium compound, copper compound, chromium compound, vanadium compound, nickel compound, alkali metal compound, rare earth compound, manganese compound, alkali earth metal compound and the like. The amount of the third component added is normally from 0.1 to 10% by weight based on the carrier.

Examples of the process for preparation of the catalyst will be described below. That is, ruthenium chloride (RuCL₃.nH₂O) is dissolved in an aqueous dilute hydrochloric acid solution to prepare an aqueous ruthenium chloride-hydrochloric acid solution. After the aqueous solution is allowed to stand for 1 day, a carrier powder such as titanium oxide is suspended in the aqueous solution and an aqueous alkali solution of an alkali metal hydroxide is added dropwise with stirring, thereby hydrolyzing ruthenium chloride with controlling to the predetermined pH, resulting in precipitation-supporting on the carrier. Furthermore, the suspension is heated with controlling the pH to accelerate the hydrolysis. The pH is normally from 3 to 7 and the heating temperature is normally from 50 to 70° C. The heating time is normally from 1 to 10 hours. Then,,the suspension is heated to evaporate to dryness, but the suspension may be heated as it is to evaporate to dryness or may also be evaporated to dryness, after it was filtered and washed with water. When evaporating to dryness as it is, it becomes possible to obtain a ruthenium oxide catalyst having smaller particle size of ruthenium oxide. The temperature for evaporation to dryness is normally from 40 to 150° C. (outer temperature) and the suspension can also be vacuum-dried. The suspension can also be evaporated to dryness, after it was allowed to stand and the supernatant is removed by decantation. The resultant is subjected to primary calcination at 100 to 200° C. for 2 to 24 hours, and then subjected to second calcination at 300 to 450° C. for 2 to 24 hours. Then, the alkali metal chloride contained in the catalyst is removed by washing with water, followed by drying at about 100° C. Examples of the atmosphere of the above preparation include air.

In the present invention, it is also possible to use a catalyst prepared by oxidizing the supported metal ruthenium catalyst in a gas containing oxygen at not more than 500° C. Incidentally, a catalyst prepared by oxidizing the supported metal ruthenium catalyst in a gas containing oxygen at 280 to 450° C. is preferable because of high activity. High activity of the catalyst can be easily realized by the oxidizing treatment.

The supported ruthenium catalyst, which is industrially used and is commercially available, is generally a supported metal ruthenium catalyst. Therefore, the catalyst in the present invention has such an advantage that, in case of using industrially, the existing catalyst or catalyst preparation technique can be easily diverted and a catalyst can be commercially available easily at cheap price.

The catalyst obtained by oxidizing the supported metal ruthenium catalyst can also be prepared by charging the supported metal ruthenium catalyst in a reactor and calcining the catalyst in a gas containing oxygen. It is also possible to use a catalyst prepared by previously oxidizing the supported metal ruthenium catalyst in the reactor. As the gas containing oxygen, air is normally used.

Examples of the carrier of the catalyst used after oxidizing the supported metal ruthenium include, like the case of the ruthenium metal catalyst, oxides and mixed oxides of elements, such as alumina, silica, silica-alumina, zeolite, diatomaceous earth, vanadium oxide, zirconium oxide, titanium oxide, etc. and metal sulfate. Preferable carriers are titanium oxide, zirconium oxide, alumina, zeolite, silica, titanium mixed oxide other than titania-silica, zirconium mixed oxide and aluminum mixed oxide, and more preferable carriers are titanium oxide, zirconium oxide and alumina. More preferable carrier is titanium oxide.

The weight ratio of ruthenium oxide to the carrier in the catalyst obtained by oxidizing the supported metal ruthenium oxide is normally within the range from 0.1/99.9 to 20/80, preferably from 0.5/99.5 to 15/85, more preferably from 1.0/99.0 to 15/85. When the amount of ruthenium is too small, the activity is lowered sometimes. On the other hand, when the amount of ruthenium oxide is too large, the price of the catalyst becomes high sometimes.

Examples of the process for production of the catalyst obtained by oxidizing the supported metal ruthenium catalyst include a process of supporting ruthenium chloride on the above described carrier and reducing with hydrogen, and a process of calcining the supported metal ruthenium catalyst, which is produced by the process of supporting ruthenium chloride on the above described carrier, forming ruthenium hydroxide due to alkali hydrolysis and reducing it with hydrogen, or a commercially available supported metal ruthenium catalyst in a gas containing oxygen.

The calcining temperature is normally not more than 500° C., preferably from 280 to 450° C. When the calcining temperature is too low, a large amount of metal ruthenium particles is remained and the catalytic activity becomes insufficient, sometimes, in comparison with the case of being sufficiently oxidized. On the other hand, when the calcining temperature is too high, agglomeration of ruthenium oxide particles occurs and the catalytic activity is lowered. The calcining time is normally from 30 minutes to 5 hours. The metal ruthenium supported on the carrier is converted into a supported ruthenium oxide catalyst. Incidentally, it can be confirmed by X-ray diffraction and XPS (X-ray photoelectron spectroscopy) that the metal ruthenium was converted into ruthenium oxide.

Examples of the third component other than ruthenium include noble metal compound other than ruthenium (e.g. palladium compound, etc.), rare earth compound, copper compound, chromium compound, nickel compound, alkali earth metal compound, manganese compound, tantalum compound, tin compound, vanadium compound and the like. The amount of the third component added is normally from 0.1 to 10% by weight based on the carrier.

In the present invention, it is also possible to use a supported ruthenium oxide catalyst obtained by calcining the supported metal ruthenium, prepared by supporting metal ruthenium on the carrier, in a gas containing oxygen in the presence of an alkali metal salt.

This catalyst have something in common with the catalyst described in the term of the catalyst obtained by oxidizing the supported metal ruthenium catalyst in a gas containing oxygen and have something in common in the respect that the supported metal ruthenium catalyst is oxidized in the gas containing oxygen, but is characterized by calcining in the presence of the alkali metal salt.

Examples of the carrier include oxides and mixed oxides of elements, such as titanium oxide, alumina, zirconium oxide, silica, titanium mixed oxide, zirconium mixed oxide, aluminum mixed oxide, silicon mixed oxide and the like. Preferable carriers are titanium oxide, alumina, zirconium oxide and silica, and more preferable carrier is titanium oxide.

The weight ratio of ruthenium oxide to the carrier is preferably within the range from 0.1/99.9 to 20/80, more preferably from 0.5/99.5 to 15/85, most preferably from 1/99 to 15/85. When the amount of the metal ruthenium is too small, the activity is lowered sometimes. On the other hand, when the amount of the metal ruthenium oxide is too large, the price of the catalyst becomes high sometimes. Examples of the process of producing the metal ruthenium supported on the carrier include a process of supporting ruthenium chloride on a carrier and reducing with hydrogen. Incidentally, a commercially available supported metal ruthenium may be used.

It is possible to obtain ruthenium oxide having higher activity by calcining metal ruthenium in a gas containing oxygen in the presence of an alkali metal salt. As the gas containing oxygen, air is normally used.

The calcining temperature is normally from 100 to 600° C., preferably from 280 to 450° C. When the calcining temperature is too low, a large amount of metal ruthenium particles is remained and the catalytic activity becomes insufficient, sometimes. On the other hand, when the calcining temperature is too high, agglomeration of ruthenium oxide particles occurs and the catalytic activity is lowered. The calcining time is normally from 30 minutes to 10 hours.

In this case, it is important to calcine in the presence of the alkali metal salt. According to this process, ruthenium oxide of more fine particles is formed, thereby making it possible to obtain higher catalytic activity in comparison with the case of calcining in the absence of the alkali metal salt, substantially.

Examples of the alkali metal salt include potassium chloride, sodium chloride, cesium nitrate and the like, preferably potassium chloride and sodium chloride, more preferably potassium chloride.

The molar ratio of the alkali metal salt to ruthenium is preferably from 0.01 to 10, more preferably from 0.1 to 5. When the amount of the alkali metal salt used is too small, a sufficient high-activity catalyst is not obtained. On the other hand, when the amount of the alkali metal salt used is too large, the cost becomes high, industrially.

The metal ruthenium supported on the carrier is converted into a supported ruthenium oxide catalyst by calcination. It can be confirmed by X-ray diffraction and XPS (X-ray photoelectron spectroscopy) that the metal ruthenium was converted into ruthenium oxide. It is preferable that the whole amount of the metal ruthenium is substantially converted into ruthenium oxide, but the metal ruthenium may be remained unless the effect of the present invention is damaged.

Examples of the process for preparation of the catalyst will be described below.

That is, there can be used a process of impregnating a supported metal ruthenium catalyst with an aqueous solution of an alkali metal salt, drying the catalyst, calcining the dried catalyst in a gas containing oxygen, followed by washing with water and further drying. As the supported metal ruthenium catalyst, a catalyst wherein the particle size of metal ruthenium particles is small is preferable. Examples of the process for preparation of the supported metal ruthenium catalyst include a process of supporting ruthenium chloride on the above described carrier and reducing it and a process of supporting ruthenium chloride on the above described carrier, producing a ruthenium hydroxide on the carrier due to alkali hydrolysis and reducing it with hydrogen. Incidentally, there may be used a commercially available supported metal ruthenium catalyst wherein the particle size of metal ruthenium particles is small. Examples of the commercially available supported metal ruthenium catalyst, wherein the particle size of metal ruthenium particles is small, include commercially available spherical (2% by weight) supported metal ruthenium catalyst on titanium oxide and spherical (5% by weight) supported metal ruthenium catalyst on titanium oxide (N.E. Chemcat Co.). The molar ratio of the alkali metal salt to ruthenium in the amount of the alkali metal salt used is preferably from 0.01 to 10, more preferably from 0.1 to 5. The calcining temperature is preferably from 280 to 450° C. The calcining time is normally from 30 minutes to 10 hours. The alkali metal salt added is removed by washing with water, but may be remained unless the catalytic activity of this catalyst is lowered.

In the present invention, it is also possible to use a supported ruthenium oxide catalyst supported on a spherical carrier having a particle size of 10 to 500 μm. Examples of the supported ruthenium oxide catalyst include catalysts prepared by supporting ruthenium oxide (e.g. ruthenium dioxide, ruthenium hydroxide, etc,) on a carrier.

Examples of the carrier of the supported ruthenium oxide catalyst include oxides and mixed oxides of elements, such as titanium oxide, alumina, zirconium oxide, silica, titanium mixed oxide, zirconium mixed oxide, aluminum mixed oxide, silicon mixed oxide and the like.

As the supported ruthenium oxide catalyst, a spherical catalyst having a particle size of 10 to 500 μm is normally used. When using in a fluidized bed reaction vessel, a catalyst in the above described form is preferably used. In the fluidized bed reaction vessel, the particle size having a certain particle size distribution is selected within the above range according to physical properties and amount of the fluid to be passed.

Examples of the process of preparation of the above ruthenium oxide catalyst include the following process. First, a spherical (10-500 μm) carrier is prepared by spraying a fine powder slurry and/or a hydrogel slurry of oxides and mixed oxides of elements, such as titanium oxide, alumina, etc., preferably titanium oxide, alumina, titanium oxide-silica mixed oxide, etc. using a spray dryer, followed by drying and further calcination. Then, ruthenium oxide is supported on the carrier by the supporting process described in the term of the supported ruthenium oxide catalyst. For example, ruthenium oxide can also be supported on the carrier by impregnating an aqueous solution of ruthenium chloride on the carrier, drying the carrier, impregnating the carrier with an aqueous solution of an alkali metal hydroxide,, hydrolyzing ruthenium chloride, followed by washing with water, drying and further calcination. The above ruthenium oxide catalyst can be prepared by the above preparation examples.

Since the catalyst has a small particle size as described above, a catalyst having high activity can be prepared by a comparatively simple process. As a result, the catalytic activity per supported ruthenium can be enhanced.

The weight ratio of ruthenium oxide to the carrier is preferably from 0.1/99.9 to 20/80, more preferably from 0.5/99.5 to 15/85. When the amount of the ruthenium oxide is too small, the activity is lowered sometimes. On the other hand, when the amount of the ruthenium oxide is too large, the price of the catalyst becomes high sometimes.

Incidentally, a third component other than ruthenium can also be added, and examples of the third component include palladium compound, copper compound, chromium compound, nickel compound, vanadium compound, alkali metal compound, rare earth compound, manganese compound, alkali earth compound and the like. The amount of the third component added is normally from 0.1 to 10% by weight based on the carrier.

The calcining temperature of those prepared by hydrolyzing ruthenium chloride and supporting on the carrier is preferably from 100 to 500° C. The calcining time of the supported one is normally from about 30 minutes to 10 hours. Particularly preferable calcining temperature is from 300 to 400° C. When the calcining temperature is too low, ruthenium is not sufficiently converted into ruthenium oxide and high activity is not obtained sometimes. On the other hand, when the calcining temperature is too high, agglomeration of ruthenium oxide particles occurs and the catalytic activity is lowered sometimes.

In the present invention, it is also possible to use a catalyst prepared by coating an inert carrier with a ruthenium oxide catalyst, or a catalyst prepared by extruding a ruthenium oxide catalyst.

The present invention relates to a process of oxidizing hydrogen chloride with oxygen by the gas phase flow reaction using the above catalyst. When using the catalyst in a fixed bed, the reaction is normally conducted by filling an industrially large-scale device with the catalyst. When the length of a catalyst bed increases, a catalyst having a predetermined particle size or more is used in order to decrease the pressure drop of the reactor. Catalysts having various particle sizes are used according to the flow amount of the gas and the length of a catalyst bed, but those having a particle size of more than 1 to 2 mm are normally used. The present invention is characterized by using the ruthenium oxide catalyst, and there could be developed a process of coating an inert carrier (e.g. alumina, silica, titanium oxide, etc.) with the ruthenium oxide catalyst without lowering the activity of the catalyst so as to increase the particle size of the catalyst. That is, there are many coating processes, and examples thereof include a process of rolling an α-alumina carrier, spraying an aqueous titanium oxide sol solution with adding a ruthenium oxide catalyst powder, thereby coating the α-alumina with the ruthenium oxide catalyst. According to this process, a catalyst having a particle size of not less than 3 mm could be prepared without lowering the activity of the catalyst.

Examples of the ruthenium oxide catalyst include supported type ruthenium oxide catalyst and ruthenium mixed oxide catalyst which have already been described. Examples of the carrier to be coated include metal oxides such as α-alumina, silica, titanium oxide, γ-alumina, zirconium oxide and the like.

The ratio of the ruthenium oxide catalyst to be supported to the carrier to be coated is normally within the range from 5/95 to 40/60.

Examples of the binder in case of coating include water, titanium oxide sol, silica sol, alumina sol and the like. Among them, titanium oxide sol is preferably used. The binder can also be used after diluting with a solvent. As the solvent, water or an organic solvent (e.g. methanol, etc.) is used. The amount is normally about 1 to 10% by weight based on the ruthenium oxide catalyst. The coated one may be calcined, if necessary, and the calcining temperature is normally from about 300 to 400° C.

Examples of the process for preparation of the catalyst having a particle size of not less than 3 mm include a process of extruding the ruthenium oxide catalyst. For example, there can also be used a process of preparing a catalyst, comprising mixing the ruthenium oxide catalyst with a titanium oxide sol and potassium chloride, kneading, extruding, drying and calcining the mixture, washing the resultant with water to remove potassium chloride, followed by drying.

Examples of the ruthenium oxide catalyst include supported type ruthenium oxide catalyst and ruthenium mixed oxide type catalyst which have already been described. Examples of the binder include water, titanium oxide sol, silica sol, alumina sol and the like. The amount is normally from about 5 to 30% by weight based on the ruthenium oxide catalyst. Potassium chloride is not used, necessarily, but is used preferably. The amount is normally from about 5 to 20% by weight based on the ruthenium oxide catalyst. The drying temperature after extrusion is normally from 150 to 250° C. and the calcining temperature is preferably from 300 to 400° C. The calcining time is normally from about 5 to 24 hours. The calcining atmosphere is preferably air. Then, washing with water and drying are normally carried out.

The catalyst in the present invention can be used in a reactor such as fixed bed reactor, fluidized reactor, tank type reactor and the like, but the preferable particle size and shape of the catalyst varies depending on the kind of the reactor used. For example, the catalyst filled in the fixed bed reactor is normally molded into a spherical, cylindrical or extruded catalyst having a size of not less than 1 mm so as to reduce a differential pressure caused by flow of a fluid. In the fluidized reactor, a spherical catalyst having a particle size of 10 to 500 μm is used, and a particle size having a certain particle size distribution is selected according to physical properties and amount of the fluid to be passed.

According to the present invention, chlorine is produced by oxidizing hydrogen chloride with oxygen using the above catalyst. In the production of chlorine, examples of the reaction system include flow system such as fixed bed, fluidized bed, etc. There can be preferably used a gas phase reaction such as fixed bed gas phase flow system, gas phase fluidized bed flow system, etc. The fixed bed system has advantages that separation between a reaction gas and a catalyst is not necessary and that high conversion can be accomplished because a contact between a raw material gas and the catalyst can be sufficiently conducted. Furthermore, the fluidized bed system has an advantage that the temperature distribution width in the reactor can be reduced because heat in the reactor can be sufficiently removed.

When the reaction temperature is high, ruthenium in the high oxidation state is sometimes volatilized and, therefore, the reaction is preferably conducted at low temperature, more preferably from 100 to 500° C., most preferably from 200 to 380° C. Also, the reaction pressure is preferably from about atmospheric pressure to 50 atm. As the oxygen raw material, air may be used as it is or pure oxygen may be used. Since other components are discharged, simultaneously, when an inert nitrogen gas is discharged from the device, pure oxygen containing no inert gas is preferred. A theoretical molar amount of oxygen for hydrogen chloride is 1/4 mol, but oxygen is preferably supplied in a 0.1- to 10-fold amount for the theoretical amount. In case of the fixed bed gas phase flow system, the amount of the catalyst used is preferably from about 10 to 20000 h⁻¹, more preferably from 20 to 1000 h⁻¹, when the amount is represented by the GHSV (Gas Hourly Space Velocity) which is the ratio of the supplying volume of hydrogen chloride per hour as the raw material under atmospheric pressure to the volume of the catalyst.

In the present invention, the process of producing chlorine, comprising reacting in an aqueous phase using a ruthenium catalyst is also included.

Examples of the ruthenium catalyst used in the reaction in the aqueous phase include ruthenium chloride, ruthenium chloride and titanium chloride, supported metal ruthenium, ruthenium oxide, supported ruthenium oxide and the like.

As the ruthenium chloride catalyst, a commercially available ruthenium chloride (RuCl₃.nH₂O) can be used. Furthermore, ruthenium compounds such as ruthenium-ammine complex hydrochloride, ruthenium bromide, ruthenium-acetylacetonato complex, ruthenium-carbonyl complex, ruthenium-organic acid salt, ruthenium-nitrosyl complex, etc. can also be used because they changes to ruthenium chloride in an aqueous hydrogen chloride solution. These ruthenium chloride compounds are used in the reaction by dissolving in the aqueous hydrogen chloride solution.

Examples of the mixture catalyst of ruthenium chloride and titanium chloride include an aqueous hydrogen chloride solution of a mixture of a ruthenium chloride compound and titanium chloride described in the ruthenium chloride catalyst. As the titanium chloride, for example, titanium tetrachloride, titanium trichloride, etc. can be used. The mixing ratio of ruthenium chloride to titanium chloride is normally from 100:1 to 100:10 in a molar ratio of ruthenium to titanium.

As the supported metal ruthenium catalyst, both commercially available supported metal ruthenium catalyst and prepared supported metal ruthenium catalyst can be used. Since ruthenium is expensive, it is preferable to use in the form of being supported on the carrier, industrially. The supported ruthenium catalyst, which is industrially used and commercially available, is generally a supported metal ruthenium catalyst. That is, the supported metal ruthenium catalyst has such an advantage that, in case of using industrially, the existing catalyst or catalyst preparation technique can be easily diverted and a catalyst can be commercially available easily at cheap price.

The supported metal ruthenium catalyst will be explained below.

Examples of the carrier of the supported metal ruthenium catalyst include oxides and mixed oxides of elements, such as alumina, silica, silica-alumina, zeolite, diatomaceous earth, vanadium oxide, zirconium oxide, titanium oxide, etc. and metal sulfate. Preferable carriers are titanium oxide, zirconium oxide, alumina, zeolite, silica, titanium mixed oxide, zirconium mixed oxide and aluminum mixed oxide. More preferable carriers are titanium oxide, zirconium oxide and alumina. Still more preferable carrier is titanium oxide. The ratio of the metal ruthenium to the carrier is normally from 0.1/99.9 to 20/80, preferably from 1/99 to 10/90. When the amount of the metal ruthenium is too small, the catalytic activity is lowered sometimes. On the other hand, when the amount of the metal ruthenium is too large, the price of the catalyst becomes high sometimes.

Examples of the process for production of the metal ruthenium supported with the carrier include a process of supporting ruthenium chloride on the above described carrier and reducing it with hydrogen and a process of supporting ruthenium chloride on the above described carrier, forming a ruthenium hydroxide on the carrier due to alkali hydrolysis and reducing it with hydrogen. Incidentally, a commercially available metal ruthenium catalyst may be used.

Incidentally, a third component other than ruthenium can also be added, and examples of the third component include noble metal compound other than ruthenium (e.g. palladium compound, etc.), rare earth compound, copper compound, chromium compound, nickel compound, alkali metal compound, alkali earth metal compound, manganese compound, tantalum compound, tin compound, vanadium compound and the like. The amount of the third component added is normally from 0.1 to 10% by weight based on the carrier.

Examples of the ruthenium oxide catalyst and supported ruthenium oxide catalyst include the following catalysts.

Examples of the ruthenium oxide catalyst include ruthenium oxide (e.g. ruthenium dioxide, ruthenium hydroxide, etc.) and ruthenium dioxide catalyst, ruthenium hydroxide catalyst, ruthenium mixed oxide, supported ruthenium oxide catalyst, etc., which are prepared by a known process (e.g. Genso-betsu Shokubai Binran, 1978, page 544, published by Chijin Shokan), but commercially available ruthenium dioxide may be used. Furthermore, a compound prepared by binding ruthenium oxide (e.g. halogenated oxide, etc.) with the other element is also used. Among them, the ruthenium mixed oxide and supported ruthenium oxide are preferable because of high activity. From industrial point of view, the supported ruthenium oxide catalyst is preferable because of cheap price. Examples of the process for preparation of a high-active ruthenium oxide catalyst, which is industrially preferable to obtain a ruthenium oxide catalyst, include a process of hydrolyzing ruthenium chloride with an alkali to form ruthenium hydroxide and calcining it in air to produce ruthenium dioxide. In this case, the calcining temperature is preferably from 300 to 400° C. Examples of the carrier of the supported ruthenium oxide include oxides and mixed oxides of elements, such as titanium oxide, alumina, zirconium oxide, silica, titanium mixed oxide, zirconium mixed oxide, aluminum mixed oxide, silicon mixed oxide and the like. Preferable carriers are titanium oxide, alumina, zirconium oxide and silica, and more preferable carrier is titanium oxide. The weight ratio of the ruthenium oxide to the carrier is normally within the range from 0.1/99.9 to 70/30, preferably from 0.1/99.9 to 20/80.

When the ratio of ruthenium is too low, the activity is lowered sometimes. On the other hand, when the ratio of ruthenium is too high, the price of the catalyst becomes high sometimes. Incidentally, a third component other than ruthenium can also be added, and examples of the third component include noble metal compound other than ruthenium (e.g. palladium compound, etc.), rare earth compound, copper compound, chromium compound, nickel compound, alkali metal compound, alkali earth metal compound, manganese compound, tantalum compound, tin compound, vanadium compound and the like. The amount of the third component added is normally from 0.1 to 10% by weight based on the carrier.

Examples of the compound supported include ruthenium oxide, ruthenium hydroxide, halogenated ruthenium oxide and the like. Examples of the industrially cheap and preferable supporting process include a process of oxidizing a supported metal ruthenium in a gas containing oxygen. As an example, a catalyst prepared by oxidizing the supported metal ruthenium in the gas containing oxygen will be described. The catalyst prepared by oxidizing the supported metal ruthenium in the present invention is a catalyst oxidized by calcining the supported metal ruthenium in the gas containing oxygen.

Examples of the catalyst prepared by oxidizing the supported metal ruthenium catalyst include a catalyst oxidized by calcining the supported metal ruthenium catalyst in the gas containing oxygen. As the gas containing oxygen, air is normally used. Examples of the carrier of the catalyst used after oxidizing the supported metal ruthenium catalyst include oxides and mixed oxides of elements, like the case of the supported metal ruthenium catalyst, such as alumina, silica, silica-alumina, zeolite, diatomaceous earth, vanadium oxide, zirconium oxide, titanium oxide, etc. and metal sulfate. Preferable carriers are titanium oxide, zirconium oxide, alumina, zeolite, silica, titanium mixed oxide, zirconium mixed oxide and aluminum mixed oxide. More preferable carriers are titanium oxide, zirconium oxide and alumina. Still more preferable carrier is titanium oxide.

The ratio of ruthenium to the carrier is normally from 0.1/99.9 to 20/80, preferably from 1/99 to 10/90, like the case of the above described supported metal ruthenium catalyst. When the amount of ruthenium is too small, the catalytic activity is lowered sometimes. On the other hand, when the amount of ruthenium is too large, the price of the catalyst becomes high sometimes.

Examples of the process for production of the catalyst obtained by oxidizing the supported metal ruthenium catalyst include a process of calcining the catalyst produced by the above described process for production of the supported metal ruthenium catalyst or commercially available supported metal ruthenium catalyst in a gas containing oxygen.

The calcining temperature is preferably from 100 to 600° C., more preferably from 280 to 450° C. When the calcining temperature is too low, a large amount of metal ruthenium particles is sometimes remained. On the other hand, when the calcining temperature is too high, agglomeration of ruthenium oxide particles occurs and the catalytic activity is sometimes lowered. The calcining time is normally from 30 minutes to 5 hours. The metal ruthenium supported on the carrier is converted into a supported ruthenium oxide catalyst by calcination. Incidentally, it can be confirmed by X-ray diffraction and XPS (X-ray photoelectron spectroscopy) that the metal ruthenium was converted into ruthenium oxide.

Incidentally, a third component other than ruthenium can also be added, like the case of the above described supported metal ruthenium catalyst, and examples of the third component include noble metal compound other than ruthenium (e.g. palladium compound, etc.), rare earth compound, copper compound, chromium compound, nickel compound, alkali metal compound, alkali earth metal compound, manganese compound, tantalum compound, tin compound, vanadium compound and the like. The amount of the third component added is normally from 0.1 to 10% by weight based on the carrier.

Examples of the supporting process of the supported ruthenium oxide include a process of impregnating a carrier with an aqueous solution of RuCl₃, adding an alkali to precipitate ruthenium hydroxide on the carrier and calcining it in air to support ruthenium oxide and a process of impregnating a carrier with an aqueous solution of RuCl₃, drying the carrier and calcining the carrier in air to support ruthenium oxide. The supported one is normally calcined at 100 to 500° C. for about 30 minutes to 5 hours. Particularly preferable calcining temperature is from 300 to 400° C. When the calcining temperature is too low, ruthenium is not sufficiently converted into ruthenium oxide and high activity is not obtained sometimes. On the other hand, when the calcining temperature is too high, agglomeration of ruthenium oxide occurs, which results in low activity.

The ruthenium oxide catalyst also includes a ruthenium mixed oxide type catalyst. The ruthenium mixed oxide type catalyst can be obtained by combining at least one oxide (e.g. titanium oxide, zirconium oxide, alumina, silica, vanadium oxide, boron oxide, chromium oxide, niobium oxide, hafnium oxide, tantalum oxide, tungsten oxide, etc.) with ruthenium oxide. Examples of the preferable compound used for production of the ruthenium mixed oxide include titanium oxide, zirconium oxide and titanium mixed oxide.

Examples of the process for production of the ruthenium mixed oxide from ruthenium oxide include a process of adding those prepared by hydrolyzing a ruthenium compound (e.g. ruthenium chloride, etc.) dissolved in water with an alkali (e.g. alkali metal hydroxide, ammonia water, etc.) to those prepared by hydrolyzing a chloride, an oxychloride, a nitrate, an oxynitrate, an alkali salt of oxy-acid or a sulfate of titanium, etc. dissolved in water with an alkali (e.g. alkali metal hydroxide, ammonia water, etc.) or those prepared by hydrolyzing an alkoxide with an acid, followed by sufficient mixing, filtration, washing and further calcination in air. The content of ruthenium oxide in the ruthenium mixed oxide is normally from 0.1 to 80% by weight. Incidentally, a third component other than ruthenium can also be added, and examples of the third component include palladium compound, copper compound, chromium compound, vanadium compound, alkali metal compound, rare earth compound, manganese compound, alkali earth metal compound and the like. The amount of the third component added is normally from 0.1 to 10% by weight based on the weight of the ruthenium mixed oxide. Examples of the process for preparation of the ruthenium mixed oxide include coprecipitation process, process by mixing of precipitate, impregnation process and the like. Examples of the process of supporting the ruthenium mixed oxide on the carrier include impregnation process, precipitation-supporting process and the like. The ruthenium mixed oxide is normally prepared by calcining at 100 to 500° C. for about 30 minutes to 5 hours. Examples of the calcining atmosphere include nitrogen, air and the like.

When the ratio of ruthenium is too low, the activity is lowered sometimes. On the other hand, when the ratio of ruthenium is too high, the price of the catalyst becomes high sometimes. Incidentally, a third component can also be added, and examples of the third component include palladium compound, copper compound, chromium compound, vanadium compound, alkali metal compound, rare earth compound, manganese compound, alkali earth metal compound and the like. The amount of the third component added is normally from 0.1 to 10% by weight based on the weight of the ruthenium mixed oxide.

The present invention relates to a process for producing chlorine, which comprises oxidizing hydrogen chloride with oxygen in an aqueous phase, using a ruthenium chloride catalyst, a ruthenium chloride catalyst and a titanium chloride catalyst, a supported ruthenium catalyst, or a ruthenium oxide catalyst. The reaction system in the production of chlorine is not specifically limited, but a flow system is preferable and a liquid phase flow system is more preferable. In case of ruthenium chloride, a tank type homogeneous aqueous phase reaction system is used. In case of a solid catalyst, a tank type slurry aqueous phase reaction system is used. In both cases, a reaction distillation system is preferably used. The temperature is preferably the temperature close to the boiling point of the aqueous hydrogen chloride solution, and varies with the pressure but is normally from 90 to 150° C. Also, the reaction pressure is not specifically limited, but is preferably from about atmospheric pressure to 10 atm. As the oxygen raw material, air may be used as it is or pure oxygen may also be used. Preferably, pure oxygen containing no inert gas is used because other components are discharged, simultaneously, when an inert gas is discharged from the device. The theoretical molar amount of oxygen for hydrogen chloride is 1/4 mol, but oxygen is preferably supplied in a 0.1- to 10-fold amount for the theoretical amount, more preferably supplied in a 0.2- to 5-fold amount for the theoretical amount. In case of using ruthenium chloride, the amount of the catalyst used is normally from 1 to 30% by weight based on the aqueous hydrogen chloride solution. In case of using the solid catalyst, the amount of the catalyst used is normally from 1 to 20% by weight based on the aqueous hydrogen chloride solution.

The following Examples further illustrate the present invention in detail but are not to be construed to limit the scope thereof.

### EXAMPLE 1

A catalyst was prepared by the following process. That is, a commercially available ruthenium chloride hydrate (RuCl₃.nH₂O) (1.66 g) was dissolved in an aqueous hydrochloric acid solution (0.1 mol/l, 1580 ml) and the mixture was allowed to stand overnight. Then, a titanium oxide powder (No. 1, manufactured by Catalyst & Chemicals industries Co., Ltd.) (12.0 g) was suspended in this solution and an aqueous potassium hydroxide solution (0.1 mol/l) was added with stirring to adjust the pH to 4.5, thereby precipitation-supporting ruthenium on titanium oxide. The amount of the aqueous potassium hydroxide solution added was 2200 ml. This suspension was heated to 60° C. with adjusting the pH to 4.5, and then stirred for 5 hours. The amount of the aqueous potassium hydroxide added was 22 ml. After the completion of stirring, the suspension was air-cooled to room temperature and allowed to stand overnight. Then, the supernatant (3000 ml) was removed and the remained suspension was evaporated to dryness on an oil bath heated to 130° C. to obtain a greenish gray powder. This greenish gray powder was heated in air from room temperature to 170° C. over 1 hour and calcined at the same temperature for 8 hours. Then, the power was heated in air from room temperature to 375° C. over 1 hour and calcined at the same temperature for 8 hours in the same way. After cooling, the resulting greenish gray powder (14.3 g) was washed with water (3.4 l) over one day, using a glass filter. Then, this powder was vacuum-dried at 60° C. using a rotary evaporator to obtain 12.1 g of a greenish gray powder. The particle size of this powder was adjusted to 12 to 18.5 mesh by molding to obtain a supported ruthenium oxide catalyst on titanium oxide. According to the same manner as that described above, 36.0 g of the same catalyst was obtained.

Incidentally, the calculated value of the content of ruthenium oxide was as follows.

RuO₂/(RuO₂+TiO₂)×100=6.0% by weight

The calculated value of the content of ruthenium was as follows.

Ru/(RuO₂+TiO₂)×100=4.6% by weight

The supported ruthenium oxide catalyst on titanium oxide(15.0 g) thus obtained was charged in a quartz reaction tube (inner diameter: 26 mm). A hydrogen chloride gas (41 ml/min.) and an oxygen gas (18 ml/min.) were respectively supplied under atmospheric pressure (in terms of 0° C., 1 atm). The quartz reaction tube was heated in an electric furnace to adjust the inner temperature (hot spot) to 325° C. 11.2 Hours after the beginning of the reaction, the gas at the reaction outlet was sampled by passing it through an aqueous 30% potassium iodide solution, and then the amount of chlorine formed and amount of the non-reacted hydrogen chloride were respectively determined by iodometric titration and neutralization titration. The conversion of hydrogen chloride was 91.9%.

### EXAMPLE 2

A catalyst was prepared by the following process. That is, a commercially available ruthenium chloride hydrate (RuCl₃.nH₂O) (0.84 g) was dissolved in an aqueous hydrochloric acid solution (0.1 mol/l, 790 ml) and the mixture was allowed to stand overnight. Then, a titanium oxide powder (No. 1, manufactured by Catalyst & Chemicals Industries Co., Ltd.) (6.0 g) was suspended in this solution and an aqueous potassium hydroxide solution (0.1 mol/l) was added with stirring to adjust the pH to 4.5, thereby precipitation-supporting ruthenium on titanium oxide. The amount of the aqueous potassium hydroxide solution added was 980 ml. This suspension was heated to 60° C. with adjusting the pH to 4.5, and then stirred for 5 hours. The amount of the aqueous potassium hydroxide added was 5 ml. After the completion of stirring, the suspension was air-cooled to room temperature and allowed to stand overnight. Then, the supernatant (1100 ml) was removed and the remained suspension was evaporated to dryness on an oil bath heated to 130° C. to obtain a gray powder. This gray powder was heated in air from room temperature to 180° C. over 1 hour and calcined at the same temperature for 8 hours. Then, the powder was heated in air from room temperature to 378° C. over 1 hour and calcined at the same temperature for 8 hours in the same way. After cooling, the resulting blackish green powder (8.09 g) was washed with water (3.2 l) over one day, using a glass filter. Then, this powder was vacuum-dried at 60° C. using a rotary evaporator to obtain 5.86 g of a blackish green powder. The particle size of this powder was adjusted to 12 to 18.5 mesh by molding to obtain a supported ruthenium oxide catalyst on titanium oxide.

Incidentally, the calculated value of the content of ruthenium oxide was as follows.

RuO₂/(RuO₂+TiO₂)×100=6.0% by weight

The calculated value of the content of ruthenium was as follows.

Ru/(RuO₂+TiO₂)×100=4.6% by weight

This catalyst was analyzed by X-ray diffraction and XPS. As a result, it was recognized that the supported one is ruthenium oxide.

The catalyst was measured by the following transmission electron microscope under the following conditions. As a result, the particle size of ruthenium oxide on the carrier was as follows.

Device: H-9000 NAR type,manufactured by Hitachi Corp.

Acceleration voltage: 300 kv

Observation magnification: 300,000

Photo magnification: 1,500,000

Sampling: dispersed on Cu mesh with microgrid

The identification of RuO₂ was decided by measuring the grating space of the high resolution image because the lattice spacing d is 0.318 nm in case of RuO₂ (110). The particle size of sixty-one RuO₂ particles was measured, respectively. As a result, the particle size of RuO₂ was from 0.8 to 7.2 nm and the mean diameter of RuO₂ was 2.73 nm.

The catalyst was diluted by mixing the supported ruthenium oxide catalyst on titanium oxide (2.50 g) thus obtained with a titanium oxide carrier (5 g) whose particle size was adjusted to 12 to 18.5 mesh, and then charged in a quartz reaction tube (inner diameter: 12 mm). A hydrogen chloride gas (200 ml/min.) and an oxygen gas (200 ml/min.) were respectively supplied under atmospheric pressure (in terms of 0° C., 1 atm). The quartz reaction tube was heated in an electric furnace to adjust the inner temperature (hot spot) to 300° C. 1.4 Hours after the beginning of the reaction, the gas at the reaction outlet was sampled by passing it through an aqueous 30% potassium iodide solution, and then the amount of chlorine formed and amount of the non-reacted hydrogen chloride were respectively determined by iodometric titration and neutralization titration.

The formation activity of chlorine per unit weight of the catalyst determined by the following equation was 4.90×10⁻⁴ mol/min·g-catalyst.

Chlorine formation activity per unit weight of catalyst (mol/min·g-catalyst)=amount of outlet chlorine formed (mol/min)/weight of catalyst (g)

### EXAMPLE 3

A catalyst was prepared by the following process. That is, a spherical (1 to 2 mm φ) 5 wt % supported metal ruthenium catalyst on titanium oxide (50.02 g, manufactured by N.E. Chemcat Co.) was impregnated with a prepared aqueous potassium chloride solution (2 mol/l, specific gravity measured by a gravimeter: 1.09) until water oozes out from the surface of the catalyst, and then dried in air at 60° C. for 10 minutes to 1 hour. This operation was repeated three times. The impregnation amount of the aqueous potassium chloride solution was 21.5 g at first time, 17.5 g at second time and 5.7 g at third time, respectively, and the total amount was 44.6 g. The calculated value of the molar ratio of potassium chloride to ruthenium was 3.4. Then, this catalyst was dried in air at 60° C. for 4 hours, heated in air from room temperature to 350° C. over about 1 hour and calcined at the same temperature for 3 hours to obtain a spherical solid. High purity water (11) was added to the resulting solid and, after stirring at room temperature for 1 minute, the catalyst was filtered. After repeating this operation ten times, the solid was dried in air at 60° C. for 4 hours to obtain 49.85 g of a spherical bluish black catalyst. This solid was ground to adjust the particle size to 12 to 18.5 mesh, thereby obtaining a supported ruthenium oxide catalyst on titanium oxide.

Incidentally, the calculated value of the content of ruthenium oxide was 6.5% by weight. The calculated value of the content of ruthenium was 4.9% by weight.

This catalyst was analyzed by X-ray diffraction. As a result, it was recognized that the supported one is ruthenium oxide. The catalyst was measured by the same transmission electron microscope as that used in Example 2 under the same conditions. Ruthenium oxide on the carrier was identified according to the same manner as that described in Example 2, and the particle size of ruthenium oxide was measured. The particle size of sixty-seven RuO₂ particles was measured, respectively. As a result, the particle size of RuO₂ was from 0.8 to 6.0 nm and the mean diameter of RuO₂ was 1.79 nm.

The supported ruthenium oxide catalyst on titanium oxide (2.5 g) thus obtained was charged in a reaction tube in the same manner as that described in Example 2. According to the same reaction manner as that described in Example 2 except for passing the hydrogen chloride gas (202 ml/min.) and the oxygen gas (213 ml/min.) and adjusting the inner temperature to 300° C., the reaction was conducted. 1.3 Hours after the beginning of the reaction, the formation activity of chlorine per unit weight of the catalyst was 5.34×10⁻⁴ mol/min·g-catalyst.

### EXAMPLE 4

A catalyst was prepared by the following process. That is, a commercially available ruthenium chloride hydrate (RuCl₃onH₂O) (0.85 g) was dissolved in an aqueous hydrochloric acid solution (0.1 mol/l, 790 ml) and the mixture was allowed to stand overnight. Then, a silica gel powder (AEROSIL-300, manufactured by Nippon Aerosil Co., Ltd.) (6.00 g) was suspended in this solution and an aqueous potassium hydroxide solution (0.1 mol/l) was added and an aqueous hydrochloric acid solution (0.1 mol/l) was added with stirring to adjust the pH to 4.5, thereby precipitation-supporting ruthenium on silica. The amount of the aqueous potassium hydroxide solution added was 1000 ml, and the amount of the aqueous hydrochloric acid added was 0.5 ml. This suspension was heated to 60° C. with adjusting the pH to 4.5, and then stirred for 5 hours. The amount of the aqueous potassium hydroxide solution added was 2 ml. After the completion of stirring, the suspension was air-cooled to room temperature and allowed to stand overnight. Then, the supernatant (1200 ml) was removed and the remained suspension was evaporated to dryness on an oil bath heated to 130° C. to obtain a black powder. This black powder was heated in air from room temperature to 170° C. over 1 hour and calcined at the same temperature for 8 hours. Then, the powder was heated in air from room temperature to 375° C. over 1 hour and calcined at the same temperature for 8 hours in the same way. After cooling, the resulting black powder (7.27 g) was washed with water (3.4 l) over 4 hours, using a glass filter. Then, this powder was vacuum-dried at 60° C. using a rotary evaporator to obtain 5.71 g of a black powder. The particle size of this powder was adjusted to 12 to 18.5 mesh by molding to obtain a supported ruthenium oxide catalyst on silica. Incidentally, the calculated value of the content of ruthenium oxide was 6.1% by weight. The calculated value of the content of ruthenium was 4.7% by weight.

The catalyst was diluted by mixing the supported ruthenium oxide catalyst on silica (2.50 g) thus obtained with a titanium oxide carrier (5 g) whose particle size was adjusted to 12 to 18.5 mesh, and then charged in a quartz reaction tube (inner diameter: 12 mm). According to the same reaction manner as that described in Example 2 except for passing the hydrogen chloride gas (200 ml/min.) and the oxygen gas (200 ml/min.) and adjusting the inner temperature to 300° C., the reaction was conducted. 1.6 Hours after the beginning of the reaction, the formation activity of chlorine per unit weight of the catalyst was 3.36×10⁻⁴ mol/min·g-catalyst.

### EXAMPLE 5

A catalyst was prepared by the following process. That is, a commercially available ruthenium chloride hydrate (RuCl₃.nH₂O) (0.85 g) was dissolved in an aqueous hydrochloric acid solution (0.1 mol/l, 790 ml) and the mixture was allowed to stand overnight. Then, an alumina powder (prepared by grinding NKHD, manufactured by Sumitomo Chemical Co., Ltd.) (6.00 g) was suspended in this solution and an aqueous potassium hydroxide solution (0.1 mol/l) was added with stirring to adjust the pH to 4.5, thereby precipitation-supporting ruthenium on alumina. The amount of the aqueous potassium hydroxide solution added was 855 ml. This suspension was heated to 60° C. with adjusting the pH to 4.5, and then stirred for 5 hours. The amount of the aqueous potassium hydroxide solution added was 10 ml. After the completion of stirring, the suspension was air-cooled to room temperature and allowed to stand overnight. Then, the supernatant (1200 ml) was removed and the remained suspension was evaporated to dryness on an oil bath heated to 130° C. to obtain a black powder. This black powder was heated in air from room temperature to 170° C. over 1 hour and calcined at the same temperature for 8 hours. Then, the powder was heated in air from room temperature to 375° C. over 1 hour and calcined at the same temperature for 8 hours in the same way. After cooling, the resulting blackish green powder (6.32 g) was washed with water (3.4 l) over 4 hours, using a glass filter. Then, this powder was vacuum-dried at 60° C. using a rotary evaporator to obtain 5.71 g of a blackish green powder. The particle size of this powder was adjusted to 12 to 18.5 mesh by molding to obtain a supported ruthenium oxide catalyst on alumina. Incidentally, the calculated value of the content of ruthenium oxide was 6.1% by weight. The calculated value of the content of ruthenium was 4.7% by weight.

The supported ruthenium oxide catalyst on alumina (2.50 g) thus obtained was charged in a quartz reaction tube in the same manner as that described in Example 2. According to the same reaction manner as that described in Example 2 except for adjusting the inner temperature to 300° C., the reaction was conducted. 1.3 Hours after the beginning of the reaction, the formation activity of chlorine per unit weight of the catalyst was 2.74×10⁻⁴ mol/min·g-catalyst.

### EXAMPLE 6

A catalyst was prepared by the following process. That is, a commercially available ruthenium chloride hydrate (RuCl₃.nH₂O) (0.85 g) was dissolved in an aqueous hydrochloric acid solution (0.1 mol/l, 790 ml) and the mixture was allowed to stand overnight. Then, a zirconium oxide powder (prepared by grinding E-26H1, manufactured by Nikki Chemical Co., Ltd.) (6.01 g) was suspended in this solution and an aqueous potassium hydroxide solution (0.1 mol/l) was added with stirring to adjust the pH to 4.5, thereby precipitation-supporting ruthenium on zirconium oxide. The amount of the aqueous potassium hydroxide solution added was 460 ml. This suspension was heated to 60° C. with adjusting the pH to 4.5, and then stirred for 5 hours. The amount of the aqueous potassium hydroxide solution added was 11.5 ml. After the completion of stirring, the suspension was air-cooled to room temperature and allowed to stand overnight. Then, the supernatant (1200 ml) was removed and the remained suspension was evaporated to dryness on an oil bath heated to 130° C. to obtain a black powder. This black powder was heated in air from room temperature to 170° C. over 1 hour and calcined at the same temperature for 8 hours. Then, the powder was heated in air from room temperature to 375° C. over 1 hour and calcined at the same temperature for 8 hours in the same way. After cooling, the resulting blackish green powder (6.9 g) was washed with water (3.4 l) over 4 hours, using a glass filter. Then, this powder was vacuum-dried at 60° C. using a rotary evaporator to obtain 5.83 g of a blackish green powder. The particle size of this powder was adjusted to 12 to 18.5 mesh by molding to obtain a supported ruthenium oxide catalyst on zirconium oxide. Incidentally, the calculated value of the content of ruthenium oxide was 6.1% by weight. The calculated value of the content of ruthenium was 4.7% by weight.

The supported ruthenium oxide catalyst on zirconium oxide (2.50 g) thus obtained was charged in a reaction tube in the same manner as that described in Example 2. According to the same reaction manner as that described in Example 2 except for adjusting the inner temperature to 300° C., the reaction was conducted. 1.5 Hours after the beginning of the reaction, the formation activity of chlorine per unit weight of the catalyst was 2.93×10⁻⁴ mol/min·g-catalyst.

### EXAMPLE 7

A catalyst was prepared by the following process. That is, a commercially available ruthenium chloride hydrate (RuCl₃onH₂O) (0.37 g) was dissolved in an aqueous hydrochloric acid solution (2 mol/l, 457 ml) and the mixture was allowed to stand for 1 hour. Then, a titanium oxide powder (No. 1, manufactured by Catalyst & Chemicals Industries Co., Ltd.) (34.7 g) was suspended in this solution and an aqueous potassium hydroxide solution (2 mol/l) was added with stirring to adjust the pH to 4.5, thereby precipitation-supporting ruthenium on titanium oxide. The amount of the aqueous potassium hydroxide solution added was 604 g. This suspension was heated to 60° C. with adjusting the pH to 4.5, and then stirred for 3 hours. The amount of the aqueous hydrochloric acid solution (2 mol/l) added was 1 g. After the completion of stirring, the suspension was air-cooled and the precipitate was filtered. The filtered one was dried at 60° C. to obtain an yellow powder. This yellow powder was heated in air from room temperature to 170° C. over 1 hour and calcined at the same temperature for 8 hours. Then, the powder was heated in air from room temperature to 375° C. over 1 hour and calcined at the same temperature for 8 hours in the same way. After cooling,a gray powder was obtained. The resulting powder was washed with water (3.5 l) over 7 hours, using a glass filter. Then, this powder was dried at 60° C. for 4 hours to obtain 33.5 g of a gray powder. The particle size of this powder was adjusted to 12 to 18.5 mesh by molding to obtain a supported ruthenium oxide catalyst on titanium oxide.

Incidentally, the calculated value of the content of ruthenium oxide was 0.50% by weight. The calculated value of the content of ruthenium was 0.38% by weight.

The supported ruthenium oxide catalyst on titanium oxide (2.5 g) thus obtained was charged in a reaction tube in the same manner as that described in Example 2. According to the same reaction manner as that described in Example 2 except for adjusting the inner temperature to 300° C. and passing the hydrogen chloride gas (192 ml/min.) and the oxygen gas (184 ml/min.), the reaction was conducted. 2 Hours after the beginning of the reaction, the formation activity of chlorine per unit weight of the catalyst was 0.35×10⁻⁴ mol/min·g-catalyst.

### EXAMPLE 8

A catalyst was prepared by the following process. That is, a commercially available ruthenium chloride hydrate (RuCl₃.nH₂O) (0.74 g) was dissolved in an aqueous hydrochloric acid solution (2 mol/l, 457 ml) and the mixture was allowed to stand for 30 minutes. Then, a titanium oxide powder (No. 1, manufactured by Catalyst & Chemicals Industries Co.,Ltd.) (34.7 g) was suspended in this solution and an aqueous potassium hydroxide solution (2 mol/l) was added with stirring to adjust the pH to 4.5, thereby precipitation-supporting ruthenium on titanium oxide. The amount of the aqueous potassium hydroxide solution added was 463 ml. This suspension was heated to 60° C. with adjusting the pH to 4.5, and then stirred for 3 hours. The amount of potassium hydroxide added was 0.5 ml. After the completion of stirring, the suspension was air-cooled and the precipitate was filtered. The filtered one was dried at 60° C. to obtain a powder. This powder was heated in air from room temperature to 170° C. over 1 hour and calcined at the same temperature for 8 hours. Then, the powder was heated in air from room temperature to 375° C. over 1 hour and calcined at the same temperature for 8 hours in the same way. After cooling, a gray powder was obtained. The resulting powder was washed with water (3 l) over 3 hours, using a glass filter. Then, this powder was dried at 60° C. for 4 hours to obtain 33.6 g of a gray powder. The particle size of this powder was adjusted to 12 to 18.5 mesh by molding to obtain a supported ruthenium oxide catalyst on titanium oxide.

Incidentally, the calculated value of the content of ruthenium oxide was 1.0% by weight. The calculated value of the content of ruthenium was 0.75% by weight.

The supported ruthenium oxide catalyst on titanium oxide (2.5 g) thus obtained was charged in a reaction tube in the same manner as that described in Example 2. According to the same reaction manner as that described in Example 2 except for adjusting the inner temperature to 300° C. and passing the hydrogen chloride gas (192 ml/min.) and the oxygen gas (184 ml/min.), the reaction was conducted. 2 Hours after the beginning of the reaction, the formation activity of chlorine per unit weight of the catalyst was 0.85×10⁻⁴ mol/min·g-catalyst.

### EXAMPLE 9

A catalyst was prepared by the following process. That is, a commercially available ruthenium chloride hydrate (RuCl₃.nH₂O) (4.23 g) was dissolved in an aqueous hydrochloric acid solution (2 mol/l, 228 ml) and the mixture was allowed to stand for 30 minutes. Then, a titanium oxide powder (No.1, manufactured by Catalyst & Chemicals Industries Co., Ltd.) (30. 0 g) was suspended in this solution and an aqueous potassium hydroxide solution (2 mol/l) was added with stirring to adjust the pH to 4.5, thereby precipitation-supporting ruthenium on titanium oxide. The amount of the aqueous potassium hydroxide solution (2 mol/l) added was 206 ml. This suspension was heated to 60° C. with adjusting the pH to 4.5, and then stirred for 5 hours. The amount of the aqueous potassium hydroxide solution (0.1 mol/l) added was 125 ml. An aqueous potassium hydroxide solution (0.1 mol/l, 102 ml) was added to adjust the pH to 7.0. After the completion of stirring, the suspension was air-cooled to room temperature and the precipitate was filtered. The filtered one was dried at 60° C. for 8 hours to obtain 33.4 g of a greenish gray powder. An aliquot (6.67 g) was obtained from this greenish gray powder, heated in air from room temperature to 170° C. over 1 hour and calcined at the same temperature for 8 hours. Then, it was heated in air from room temperature to 375° C. over 1 hour and calcined at the same temperature for 8 hours in the same way. After cooling, a greenish gray powder was obtained. The resulting powder was washed with water (3 l) over 3 hours, using a glass filter. Then, this powder was vacuum-dried at 60° C. using a rotary evaporator to obtain 6.01 g of a black powder. The particle size of this powder was adjusted to 12 to 18.5 mesh by molding to obtain a supported ruthenium oxide catalyst on titanium oxide.

Incidentally, the calculated value of the content of ruthenium oxide was 6.2% by weight. The calculated value of the content of ruthenium was 4.7% by weight.

The supported ruthenium oxide catalyst on titanium oxide (2.50 g) thus obtained was charged in a quartz reaction tube in the same manner as that described in Example 2. According to the same reaction manner as that described in Example 2 except for adjusting the inner temperature to 301° C. and passing the hydrogen chloride gas (190 ml/min.), the reaction was conducted. 2.1 Hours after the beginning of the reaction, the formation activity of chlorine per unit weight of the catalyst was 4.90×10⁻⁴ mol/min.·g-catalyst.

### EXAMPLE 10

A catalyst was prepared by the following process. That is, a commercially available ruthenium chloride hydrate (RuCl₃.nH₂O) (13.0 g) was dissolved in an aqueous hydrochloric acid solution (2 mol/l, 606 ml) and the mixture was allowed to stand for 30 minutes. Then,a titanium oxide powder (No.1, manufactured by Catalyst & Chemicals Industries Co., Ltd.) (34.7 g) was suspended in this solution and an aqueous potassium hydroxide solution (2 mol/l) was added with stirring to adjust the pH to 4.5, thereby precipitation-supporting ruthenium on titanium oxide. The amount of the aqueous potassium hydroxide solution added was 675 ml. This suspension was heated to 60° C. with adjusting the pH to 4.5, and then stirred for 3 hours. The amount of potassium hydroxide added was 3 ml. After the completion of stirring, the suspension was air-cooled and the precipitate was filtered. The filtered one was dried at 60° C. to obtain a greenish gray powder. This greenish gray powder was heated in air from room temperature to 170° C. over 1 hour and calcined at the same temperature for 8 hours. Then, the powder was heated in air from room temperature to 375° C. over 1 hour and calcined at the same temperature for 8 hours in the same way. After cooling, 44.0 g of a greenish gray powder was obtained. An aliquot (8.0 g) was obtained from this powder and washed with water (3 l) over 3 hours, using a glass filter. Then, this powder was dried at 60° C. for 8 hours to obtain 6.8 g of a greenish gray powder. The particle size of this powder was adjusted to 12 to 18.5 mesh by molding to obtain a supported ruthenium oxide catalyst on titanium oxide.

Incidentally, the calculated value of the content of ruthenium oxide was 14.9% by weight. The calculated value of the content of ruthenium was 11.3% by weight.

The supported ruthenium oxide catalyst on titanium oxide (2.50 g) thus obtained was charged in a quartz reaction tube in the same manner as that described in Example 2. According to the same reaction manner as that described in Example 2 except for adjusting the inner temperature to 300° C. and passing the hydrogen chloride gas (190 ml/min.), the reaction was conducted. 2.0 Hours after the beginning of the reaction, the formation activity of chlorine per unit weight of the catalyst was 6.1×10⁻⁴ mol/min·g-catalyst.

### EXAMPLE 11

A catalyst was prepared by the following process. That is, a commercially available ruthenium chloride hydrate (RuCl₃.nH₂0) (18.4 g) was dissolved in an aqueous hydrochloric acid solution (2 mol/l, 861 ml) and the mixture was allowed to stand for 30 minutes. Then,a titanium oxide powder(No.1, manufactured by Catalyst & Chemicals Industries Co., Ltd.) (34.7 g) was suspended in this solution and an aqueous potassium hydroxide solution (2 mol/l) was added with stirring to adjust the pH to 4.5, thereby precipitation-supporting ruthenium on titanium oxide. The amount of the aqueous potassium hydroxide solution added was 990 ml. This suspension was heated to 60° C. with adjusting the pH to 4.5, and then stirred for 3 hours. The amount of potassium hydroxide added was 7 ml. After the completion of stirring, the suspension was air-cooled to room temperature and the precipitate was filtered. The filtered one was dried at 60° C. to obtain a greenish gray powder. This greenish gray powder was heated in air from room temperature to 170° C. over 1 hour and calcined at the same temperature for 8 hours. Then, the powder was heated in air from room temperature to 375° C. over 1 hour and calcined at the same temperature for 8 hours in The same way. After cooling, 47.2 g of a greenish gray powder was obtained. An aliquot (8.2 g) was obtained from this greenish gray powder and washed with water (3 l) over 3 hours, using a glass filter. Then, this powder was dried at 60° C. for 8 hours to obtain 6.8 g of a greenish gray powder. The particle size of this powder was adjusted to 12 to 18.5 mesh by molding to obtain a supported ruthenium oxide catalyst on titanium oxide.

Incidentally, the calculated value of the content of ruthenium oxide was 19.9% by weight. The calculated value of the content of ruthenium was 15.0% by weight.

The supported ruthenium oxide catalyst on titanium oxide (2.50 g) thus obtained was charged in a quartz reaction tube in the same manner as that described in Example 2. According to the same reaction manner as that described in Example 2 except for adjusting the inner temperature to 300° C. and passing the hydrogen chloride gas (190 ml/min.), the reaction was conducted. 1.9 Hours after the beginning of the reaction, the formation activity of chlorine per unit weight of the catalyst was 7.1×10⁻⁴ mol/min·g-catalyst.

### EXAMPLE 12

A catalyst was prepared by the following process. That is, a spherical (1 to 2 mm φ) 5 wt % supported metal ruthenium catalyst on titanium oxide (manufactured by N.E. Chemcat Co.) was heated in air from room temperature to 350° C. over about 1 hour and calcined at the same temperature for 3 hours to obtain 5.08 g of a spherical bluish black solid. The resulting solid was ground to adjust the particle size to 12 to 18.5 mesh, thereby obtaining a catalyst wherein a supported metal ruthenium catalyst on titanium oxide is oxidized. Incidentally, the resulting catalyst was analyzed by X-ray diffraction and XPS (X-ray photoelectron spectroscopy). As a result, the presence of the ruthenium oxide particles was confirmed, but no metal ruthenium was detected by X-ray diffraction. The presence of ruthenium oxide was confirmed by XPS, but no metal ruthenium was detected.

Incidentally, the calculated value of the content of ruthenium oxide was 6.5% by weight. The calculated value of the content of ruthenium was 4.9% by weight.

The catalyst was diluted by sufficiently mixing the supported ruthenium oxide catalyst on titanium oxide (2.5 g) thus obtained with a titanium oxide carrier (5 g) whose particle size was adjusted to 12 to 18.5 mesh, and then charged in a quartz reaction tube (inner diameter: 12 mm). According to the same reaction manner as that described in Example 2 except for passing the hydrogen chloride gas (190 ml/min.) and the oxygen gas (200 ml/min.) and adjusting the inner temperature to 300° C., the reaction was conducted. 2.3 Hours after the beginning of the reaction, the formation activity of chlorine per unit weight of the catalyst was 3.59×10⁻⁴ mol/min·g-catalyst.

### EXAMPLE 13

A catalyst was prepared by the following process. That is, commercially available tetraethyl orthosilicate (41.9 g) was dissolved in ethanol (93 ml) and titanium tetraisopropoxide (56.7 g) was poured into the solution with stirring at room temperature and the solution was stirred at room temperature for 1 hour. Then, a solution which is obtained by sufficiently mixing an aqueous acetic acid solution (0.01 mol/l), prepared by dissolving acetic acid (0.14 g) in high purity water (233 ml), with ethanol (93 ml) was added to the above solution dropwise. As the water solution added dropwise, a white precipitate was formed. After the completion of the dropwise addition, the solution was stirred at room temperature for 1 hour. Then, the solution was heated with stirring and refluxed on an oil bath at 110° C. for 1 hour. The temperature of the solution at this time was 80° C. This solution was air-cooled, filtered with a glass filer, washed with high purity water (500 ml) and then filtered again. After this operation was repeated twice, the resultant was dried in air at 60° C. for 1 hour, heated from room temperature to 550° C. for 1 hour and then calcined at the same temperature for 3 hours to obtain 19.8 g of a white solid. The resulting solid was ground to obtain a titania silica powder.

The resulting titania silica powder (12.0 g) was impregnated with a solution prepared by dissolving a commercially available ruthenium chloride hydrate (RuCl₃.nH₂O, content of Ru: 35.5%) (1.69 g) in water (2.5 g),followed by drying in air at 60° C. for 1 hour to support ruthenium chloride. The supported one was heated from room temperature to 300° C. under a mixed flow of hydrogen (50 ml/min.) and nitrogen (100 ml/min.) over 1 hour and 30 minutes, reduced at the same temperature for 1 hour and then cooled to room temperature to obtain 12.5 g of a black supported metal ruthenium on titania silica powder.

The resulting supported metal ruthenium on titania silica powder (6.2 g) was heated from room temperature to 350° C. in an air flow (100 ml/min) over 2 hours and then calcined at the same temperature for 3 hours to obtain 5.8 g of a black powder. The particle size of the resulting powder was adjusted to 12 to 18.5 mesh by molding to obtain a supported ruthenium oxide catalyst on titania silica.

Incidentally, the calculated value of the content of ruthenium oxide was as follows.

RuO₂/(RuO₂+TiO₂+SiO₂)×100=6.1% by weight

The calculated value of the content of ruthenium was as follows.

Ru/(RuO₂+TiO₂+SiO₂)×100=4.7% by weight

The supported ruthenium oxide catalyst on titania silica (2.5 g) thus obtained was charged in a reaction tube in the same manner as that described in Example 2 without diluting with the titanium oxide carrier. According to the same reaction manner as that described in Example 2 except for passing the hydrogen chloride gas (202 ml/min.) and the oxygen gas (213 ml/min.) and adjusting the inner temperature to 301° C., the reaction was conducted. 2.4 Hours after the beginning of the reaction, the formation activity of chlorine per unit weight of the catalyst was 1.44×10⁻⁴ mol/min·g-catalyst.

### EXAMPLE 14

A catalyst was prepared by the following process. That is, commercially available tetraethyl orthosilicate (41.7 g) was dissolved in ethanol (186 ml) and titanium tetraisopropoxide (56.8 g) was poured into the solution with stirring at room temperature and the solution was stirred at room temperature for 30 minutes. Then, a solution which is obtained by sufficiently mixing an aqueous acetic acid solution (0.01 mol/l), prepared by dissolving acetic acid (0.14 g) in high purity water (233 ml), with ethanol (93 ml) was added to the above solution dropwise. As the water solution added dropwise, a white precipitate was formed. After the completion of the dropwise addition, the solution was stirred at room temperature for 30 minutes. Then, the sokution was heated with stirring and refluxed on an oil bath at 102° C. for 1 hour. The temperature of the solution at this time was 80° C. This solution was air-cooled, filtered with a glass filer, washed with high purity water (500 ml) and then filtered again. After this operation was repeated twice, the resultant was dried in air at 60° C. for 4 hours, heated from room temperature to 550° C. for 1 hour and then calcined at the same temperature for 3 hours to obtain 27.4 g of a white solid. The resulting solid was ground to obtain a titania silica powder.

The resulting titania silica powder (7.0 g) was impregnated with a solution prepared by dissolving a commercially available ruthenium chloride hydrate (RuCl₃.nH₂O, content of Ru: 35.5%) (0.97 g) in water (7.2 g), followed by drying in air at 60° C. for 1 hour to support ruthenium chloride. The supported one was heated from room temperature to 300° C. under a mixed flow of hydrogen (50 ml/min.) and nitrogen (100 ml/min.) over 1 hour and 30 minutes, reduced at the same temperature for 1 hour and then air-cooled to room temperature to obtain a grayish brown supported metal ruthenium on titania silica powder.

The resulting supported metal ruthenium on titania silica powder was heated from room temperature to 300° C. in an air flow (100 ml/min) over 1 hour and then calcined at the same temperature for 3 hours to obtain 7.5 g of a gray powder. The particle size of the resulting powder was adjusted to 12 to 18.5 mesh by molding to obtain a supported ruthenium oxide catalyst on titania silica.

Incidentally, the calculated value of the content of ruthenium oxide was as follows.

RuO₂/(RuO₂+TiO₂+SiO₂)×100=6.1% by weight.

The calculated value of the content of ruthenium was as follows.

Ru/(RuO₂+TiO₂+SiO₂)×100=4.6% by weight.

The supported ruthenium oxide catalyst on titania silica (2.5 g) thus obtained was charged in a reaction tube in the same manner as that described in Example 2. According to the same reaction manner as that described in Example 2 except for passing the hydrogen chloride gas (180 ml/min.) and the oxygen gas (180 ml/min.) and adjusting the inner temperature to 300° C., the reaction was conducted. 1.8 Hours after the beginning of the reaction, the formation activity of chlorine per unit weight of the catalyst was 2.00×10⁻⁴ mol/min·g-catalyst.

### EXAMPLE 15

A catalyst was prepared by the following process. That is, the supported metal ruthenium on titania silica powder obtained by the same preparation process as that described in Example 14 was heated from room temperature to 450° C. in an air atmosphere over 2 hours and 30 minutes, and then calcined at the same temperature for 3 hours to obtain 7.6 g of a gray powder. The particle size of the resulting powder was adjusted to 12 to 18.5 mesh by molding to obtain a supported ruthenium oxide catalyst on titania silica.

Incidentally, the calculated value of the content of ruthenium oxide was as follows.

RuO₂/(RuO₂+TiO₂+SiO₂)×100=6.1% by weight.

The calculated value of the content of ruthenium was as follows. Ru/(RuO₂+TiO₂+SiO₂)×100=4.6% by weight

The supported ruthenium oxide catalyst on titania silica (2.5 g) thus obtained was charged in a reaction tube in the same manner as that described in Example 2. According to the same reaction manner as that described in Example 2 except for passing the hydrogen chloride gas (180 ml/min.) and the oxygen gas (180 ml/min.) and adjusting the inner temperature to 300° C., the reaction was conducted. 1.8 Hours after the beginning of the reaction, the formation activity of chlorine per unit weight of the catalyst was 1.14×10⁻⁴ mol/min·g-catalyst.

### EXAMPLE 16

A catalyst was prepared by the following process. That is, a spherical (1 to 2 mm φ) 5 wt % supported metal ruthenium catalyst on titanium oxide (6.02 g, manufactured by N.E. Chemcat Co.) was impregnated with a prepared aqueous potassium chloride solution (0.5 mol/l) until water oozes out from the surface of the catalyst, and then dried in air at 60° C. for 10 minutes to 1 hour. This operation was repeated twice. The impregnation amount of the aqueous potassium chloride solution was 3.04 g at first time and 2.89 g at second time, respectively, and the total amount was 5.93 g. The calculated value of the molar ratio of potassium chloride to ruthenium was 1.0. Then, this catalyst was dried in air at 60° C. for 4 hours, heated in air from room temperature to 350° C. over about 1 hour and calcined at the same temperature for 3 hours to obtain a spherical solid. High purity water (500 ml) was added to the resulting solid and, after stirring at room temperature for 1 minute, the catalyst was filtered. After repeating this operation four times, the solid was dried in air at 60° C. for 4 hours to obtain 5.89 g of a spherical bluish black catalyst. This solid was ground to adjust the particle size to 12 to 18.5 mesh, thereby obtaining a supported ruthenium oxide catalyst on titanium oxide. The calculated value of the content of ruthenium oxide was 6.5% by weight. The calculated value of the content of ruthenium was 4.9% by weight.

The supported ruthenium oxide catalyst on titanium oxide (2.50 g) thus obtained was charged in a quartz reaction tube in the same manner as that described in Example 2. According to the same reaction manner as that described in Example 2 except for passing the hydrogen chloride gas (202 ml/min.) and the oxygen gas (213 ml/min.) and adjusting the inner temperature (hot spot) to 301° C., the reaction was conducted. 1.5 Hours after the beginning of the reaction, the formation activity of chlorine per unit weight of the catalyst was 4.19×10⁻⁴ mol/min·g-catalyst.

### EXAMPLE 17

A catalyst was prepared by the following process. That is, a spherical (1 to 2 mm φ) 5 wt % supported metal ruthenium catalyst on titanium oxide (6.0 g, manufactured by N.E. Chemcat Co.) was impregnated with a prepared aqueous potassium chloride solution (4 mol/l) until water oozes out from the surface of the catalyst, and then dried in air at 60° C. for 10 minutes to 1 hour. This operation was repeated twice. The impregnation amount of the aqueous potassium chloride solution was 2.95 g at first time and 3.72 g at second time, respectively, and the total amount was 6.67 g. The calculated value of the molar ratio of potassium chloride to ruthenium was 10.0. Then, this catalyst was dried in air at 60° C. for 4 hours, heated in air from room temperature to 350° C. over about 1 hour and calcined at the same temperature for 3 hours. As a result, the spherical catalyst was broken and a powder was obtained. High purity water (500 ml) was added to the resulting solid and, after stirring at room temperature for 1 minute, the catalyst was filtered. After repeating this operation four times, the solid was dried in air at 60° C. for 4 hours to obtain 5.37 g of a bluish black powder catalyst. The particle size of the resulting powder was adjusted to 12 to 18.5 mesh by molding to obtain a supported ruthenium oxide catalyst on titanium oxide. The calculated value of the content of ruthenium oxide was 6.5% by weight. The calculated value of the content of ruthenium was 4.9% by weight.

The supported ruthenium oxide catalyst on titanium oxide (2.46 g) thus obtained was charged in a quartz reaction tube in the same manner as that described in Example 2. According to the same manner as that described in Example 2 except for passing the hydrogen chloride gas (190 ml/min.) and the oxygen gas (200 ml/min.) and adjusting the inner temperature to 301° C., the reaction was conducted. 1.4 Hours after the beginning of the reaction, the formation activity of chlorine per unit weight of the catalyst was 4.14×10⁻⁴ mol/min·g-catalyst.

### EXAMPLE 18

A catalyst was prepared by the following process. That is, a spherical (1 to 2 mm φ) 5 wt % supported metal ruthenium catalyst on titanium oxide (5.00 g, manufactured by N.E. Chemcat Co.) was impregnated with a prepared aqueous sodium chloride solution (2 mol/l) until water oozes out from the surface of the catalyst, and then dried in air at 60° C. for 30 minutes to 1 hour. This operation was repeated twice. The impregnation amount of the aqueous sodium chloride solution was 2.28 g at first time and 2.12 g at second time, respectively, and the total amount was 4.40 g. This catalyst was dried in air at 60° C. for 4 hours. The calculated value of the molar ratio of sodium chloride to ruthenium (NaCl/Ru) was 3.3. Then, this catalyst was dried in air at 60° C. for 4 hours, heated in air from room temperature to 350° C. over about 1 hour and calcined at the same temperature for 3 hours. As a result, a spherical solid was obtained. High purity water (500 ml) was added to the resulting solid and, after stirring at room temperature for 1 minute, the catalyst was filtered. After repeating this operation three times, the solid was dried in air at 60° C. for 4 hours to obtain 4.80 g of a spherical bluish black catalyst. This solid was ground to adjust the particle size to 12 to 18.5 mesh, thereby obtaining a supported ruthenium oxide catalyst on titanium oxide. The calculated value of the content of ruthenium oxide was 6.5% by weight. The calculated value of the content of ruthenium was 4.9% by weight.

The supported ruthenium oxide catalyst on titanium oxide (2.51 g) thus obtained was charged in a quartz reaction tube in the same manner as that described in Example 2. According to the same reaction manner as that described in Example 2 except for passing the hydrogen chloride gas (190 ml/min.) and adjusting the inner temperature to 301° C., the reaction was conducted. 1.3 Hours after the beginning of the reaction, the formation activity of chlorine per unit weight of the catalyst was 4.28×10⁻⁴ mol/min·g-catalyst.

### EXAMPLE 19

A catalyst was prepared by the following process. That is, ruthenium chloride RuCl₃.nH₂O (Ru content; 35.5%) (2.11 g) was dissolved in water (6.8 g). Then, a spherical catalyst carrier for fluidized bed reaction (content of titanium oxide: 60%, content of silica: 40%, particle size: 10-90 μm, statistical average: 41.2 μm, manufactured by a catalyst manufacture) (15.0 g) was impregnated with the total amount of the already prepared aqueous ruthenium chloride solution, and then dried at 60° C. for 30 minutes. The carrier obtained by impregnating ruthenium chloride was added to an aqueous solution prepared by dissolving 96% sodium hydroxide (1.12 g) in water (20.6 g), and then the mixture was stirred and allowed to stand for 10 minutes. Then, an aqueous mixed solution of 61% nitric acid (0.46 g) and water (20.8 g) was added to adjust the pH to 7. The resulting black catalyst was collected by filtration and washed four times with deionized water (500 ml). The catalyst was dried at 60° C. for 4 hours, heated to 350° C. over about 3 hours and 30 minutes and then calcined at the same temperature for 3 hours to obtain 15.1 g of a black catalyst. Incidentally, the calculated value of the content of ruthenium oxide was as follows.

RuO₂/(RuO₂+TiO₂)×100=6.2% by weight

The calculated value of the content of ruthenium was 4.7% by weight.

The supported ruthenium oxide catalyst for fluidized bed (0.2 g) thus obtained was charged in a reaction tube in the same manner as that described in Example 2 except for using no diluting titanium oxide carrier. According to the same reaction manner as that described in Example 2 except for passing the hydrogen chloride gas (190 ml/min.) and adjusting the inner temperature to 300° C., the reaction was conducted. 1.7 Hours after the beginning of the reaction, the formation activity of chlorine per unit weight of the catalyst was 7.65×10⁻⁴ mol/min·g-catalyst.

### EXAMPLE 20

A catalyst was prepared by the following process. That is, a commercially available ruthenium chloride hydrate (RuCl₃.nH₂O, Ru content; 35.5%) (18.4 g) was dissolved in an aqueous hydrochloric acid solution (2.0 mol/l, 861 ml) and the mixture was allowed to stand for 30 minutes. Then, a titanium oxide powder (No. 1, manufactured by Catalyst & Chemicals Industries Co., Ltd.) (34.7 g) was suspended in an aqueous hydrochloric acid solution of ruthenium chloride and an aqueous potassium hydroxide solution (2.0 mol/l) was added with stirring to adjust the pH to 4.5, thereby precipitation-supporting ruthenium on titanium oxide. The amount of the aqueous potassium hydroxide solution added was 983 ml. This suspension was heated to 60° C. with adjusting the pH to 4.5, and then stirred for 3 hours. The amount of the aqueous potassium hydroxide solution (2.0 mol/l) added was 15 ml. After the completion of stirring, the suspension was air-cooled and a blackish green powder was filtered. The filtered substance was dried at 60° C. for 4 hours. This gray powder was heated in air from room temperature to 170° C. over 1 hour and calcined at 170° C. for 8 hours. Then, the powder was heated in air from room temperature to 375° C. over 1 hour and calcined at 375° C. for 8 hours in the same way. After cooling, 48.7 g of a gray powder was obtained.

Then, an α-alumina carrier was coated with the above ruthenium oxide catalyst by the following process. That is, α-alumina (3 mm sphere, manufactured by Fujimi Inc.) (8 g) was charged in an evaporation dish (diameter was 12 cm). And an aliquot (3.43 g) was obtained from the above catalyst powder and was gradually added to the evaporation dish with rolling. Then, a solution containing 5% by weight of a titanium oxide sol was frequently sprayed at the same time to coat the carrier. The amount of the aqueous solution added was 3.8 g. The solution containing the titanium oxide sol was prepared previously by diluting a 38 wt % titanium oxide sol (CSB, manufactured by Sakai Chemical Industry Co., Ltd.) with water. The coated one was dried at 60° C., heated from room temperature to 350° C. over 2.7 hours and then calcined at the same temperature for 3 hours. After cooling, the resultant was washed with water (2.0 L) over 6 hours using a glass filter. It was confirmed that no chlorine ion is contained in the washing water using an aqueous silver nitrate solution. Then, it was dried at 60° C. for 8 hours in a dryer to obtain 11.1 g of a supported ruthenium oxide catalyst on titanium oxide which was coated on the α-alumina carrier. The content of ruthenium oxide in the coated catalyst was analyzed. The content of ruthenium by means of ICP (Inductively Coupled Plasma) atomic emission spectrosopy was 2.9% by weight.

The catalyst was diluted by sufficiently mixing the coated catalyst (2.5 g) thus obtained with a spherical (2-4 mm sphere) titanium oxide carrier and then charged in a quartz reaction tube. According to the same reaction manner as that described in Example 2 except for passing the hydrogen chloride gas (189 ml/min.) and the oxygen gas (198 ml/min.) and adjusting the inner temperature to 299° C., the reaction was conducted. 2.0 Hours after the beginning of the reaction, the formation activity of chlorine per unit weight of the catalyst was 3.86×10⁻⁴ mol/min·g-catalyst.

### EXAMPLE 21

A catalyst was prepared by the following process. That is, a commercially available ruthenium chloride hydrate (RuCl₃.nH₂O, Ru content; 35.5%) (20.5 g) was dissolved in an aqueous hydrochloric acid solution (2.0 mol/l, 960 ml) and the mixture was allowed to stand for 30 minutes. Then, a titanium oxide powder (No. 1, manufactured by Catalyst & Chemicals Industries Co., Ltd.) (22.4 g) was suspended in an aqueous hydrochloric acid solution of ruthenium chloride and an aqueous potassium hydroxide solution (2.0 mol/l) was added with stirring to adjust the pH to 4.5, thereby precipitation-supporting ruthenium on titanium oxide. The amount of the aqueous potassium hydroxide solution added was 1070 ml. This suspension was heated to 60° C. with adjusting the pH to 4.5, and then stirred for 3 hours. The amount of the aqueous potassium hydroxide solution (2.0 mol/l) added was 8 ml. After the completion of stirring, the suspension was air-cooled to room temperature and a blackish green powder was filtered. The filtered substance was dried at 60° C. for 4 hours. This gray powder was heated in air from room temperature to 170° C. over 1 hour and calcined at 170° C. for 1 hour. Then, the powder was heated in air from room temperature to 375° C. over 1 hour and calcined at 375° C. for 8 hours in the same way. After cooling, 48.6 g of a gray powder was obtained.

Then, an α-alumina carrier was coated with the above ruthenium oxide catalyst by the following process. That is, a-alumina (3 mm sphere, manufactured by Fujimi Inc.) (8 g) was charged in an evaporation dish (diameter was 12 cm). And an aliquot (2.0 g) was obtained from the above catalyst powder and was gradually added to the evaporation dish with rolling. Then, a methanol solution containing 5% by weight of a titanium oxide sol was frequently sprayed at the same time to coat the carrier. The amount of the methanol solution added was 6.7 g. The methanol solution containing the titanium oxide sol was prepared previously by diluting a 38 wt % titanium oxide sol (CSB, manufactured by Sakai Chemical Industry Co., Ltd.) with methanol. The coated one was dried at 60° C., heated from room temperature to 350° C. over 2.7 hours and then calcined at the same temperature for 3 hours. After cooling, the resultant was washed with water (3.0 L) over 6 hours using a glass filter. It was confirmed that no chlorine ion is contained in the washing water using an aqueous silver nitrate solution. Then, it was dried at 60° C. for 8 hours in a dryer to obtain 10.1 g of a supported ruthenium oxide catalyst on titanium oxide coated on the α-alumina carrier.

The catalyst was diluted by sufficiently mixing the coated catalyst (8.0 g) thus obtained with a spherical (2-4 mm sphere) titanium oxide carrier (24 g) and then charged in a quartz reaction tube. According to the same reaction manner as that described in Example 2 except for passing the hydrogen chloride gas (700 ml/min.) and the oxygen gas (700 ml/min.) and adjusting the inner temperature to 300° C., the reaction was conducted. 2.2 Hours after the beginning of the reaction, the formation activity of chlorine per unit weight of the catalyst was 4.13×10⁻⁴ mol/min·g-catalyst.

### EXAMPLE 22

A catalyst was prepared by the following process. That is, a commercially available ruthenium chloride hydrate (RuCl₃.nH₂O, Ru content: 35.5%) (4.23 g) was dissolved in an aqueous hydrochloric acid solution (2.0 mol/l, 195 ml) and the mixture was allowed to stand for 30 minutes. Then, a titanium oxide powder (No. 1, manufactured by Catalyst & Chemicals Industries Co., Ltd.) (30.0 g) was suspended in an aqueous hydrochloric acid solution of ruthenium chloride and an aqueous potassium hydroxide solution (2 mol/l) was added with stirring to adjust the pH to 4.5, thereby precipitation-supporting ruthenium on titanium oxide. The amount of the aqueous potassium hydroxide solution added was 230 ml. This suspension was heated to 60° C. with adjusting the pH to 4.5, and then stirred for 5 hours. The amount of the aqueous potassium hydroxide solution (0.1 mol/l) added was 28 ml. After the completion of stirring, the suspension was air-cooled to room temperature and an aqueous potassium hydroxide solution (0.1 mol/l, 88 ml) was added to adjust the pH to 7, and then a blackish green powder was filtered. The amount of the filtered substance (cake) was 63.3 g. An aliqout (12.6 g) was obtained from the powder and a 38 wt % titanium oxide sol (CSB, manufactured by Sakai Kagaku Co., Ltd.) (1.57 g) and potassium chloride (0.6 g) were added. The mixture was sufficiently kneaded and then extruded to form a clay-like extrudate (diameter was 4 mm). The extrudate was dried at 60° C. for 4 hours. This extrudate was heated in air from room temperature to 170° C. over 1 hour and calcined at 170° C. for 8 hours. Then, the extrudate was heated in air from room temperature to 375° C. over 1 hour and heated at 375° C. for 8 hours. After cooling, the resulting extruded molded article (6.83 g) was washed with water (6.0 L) over 8 hours, using a glass filter. Then, this extruded molded article was dried in a dryer at 60° C. for 8 hours to obtain 5.75 g of a grayish green supported ruthenium oxide catalyst on titanium oxide. The calculated value of the content of ruthenium oxide was 6.3% by weight. The calculated value of the content of ruthenium was 4.7% by weight. A catalyst supplied to the reaction was obtained by adjusting the particle size of this catalyst to 2 to 4 mm.

The catalyst was diluted by sufficiently mixing the molded catalyst (2.5 g) with a spherical (2-4 mm sphere) titanium oxide carrier, and then charged in a quartz reaction tube. According to the same reaction manner as that described in Example 2 except for passing the hydrogen chloride gas (202 ml/min.) and the oxygen gas (213 ml/min.) and adjusting the inner temperature to 300° C., the reaction was conducted. 1.4 Hours after the beginning of the reaction, the formation activity of chlorine per unit weight of the catalyst was 4.27×10⁻⁴ mol/min·g-catalyst.

### EXAMPLE 23

16 wt % hydrochloric acid (100 g) was charged in an ice-cooled flask, and commercially available titanium tetrachloride (0.87 g) was added dropwise in a nitrogen atmosphere under stirring. After sufficient stirring, a commercially available ruthenium chloride hydrate (RuCl₃.nH₂O) (28.24 g) was dissolved. This aqueous solution was refluxed by heating in an oil bath at 120° C. Oxygen (200 ml/min) was fed to this aqueous solution under a atmospheric pressure to initiate the reaction. The liquid temperature at the beginning of the reaction was 104° C. Thirty minutes after the beginning of the reaction, the gas at the reaction outlet was sampled for 20 minutes by passing it through an aqueous 30% potassium iodide solution, and then the amount of chlorine formed was determined by iodometric titration. The amount of chlorine formed was 0.04 mmol.

### EXAMPLE 24

A spherical (1-2 mm φ) 5 wt % supported metal ruthenium catalyst on titanium oxide (10.02 g, manufactured by N.E. Chemcat Co.) was ground and suspended in 20 wt % hydrochloric acid (98 g) charged in a glass flask under stirring. This aqueous solution was refluxed by heating in an oil bath at 120° C. Oxygen (200 ml/min) was fed to this aqueous solution under a atmosphric pressure to initiate the reaction. The liquid temperature at the beginning of the reaction was 109° C. From the beginning of the reaction, the gas at the reaction outlet was sampled for 60 minutes by passing it through an aqueous 30% potassium iodide solution, and then the amount of chlorine formed was determined by iodometric titration. The amount of chlorine formed was 2.87 mmol.

### COMPARATIVE EXAMPLE 1

A catalyst was prepared by the following process. That is, a commercially available ruthenium chloride hydrate (RuCl₃.nH₂O) (0.70 g) was dissolved in water (4.0 g). After the aqueous solution was sufficiently stirred, silica (Cariact G-10, manufactured by Fuji Silysia Chemical Co., Ltd.) (5.0 g), obtained by adjusting a particle size to 12 to 18.5 mesh and drying in air at 500° C. for 1 hour, to impregnate and support ruthenium chloride. The supported one was heated from room temperature to 100° C. under a nitrogen flow (100 ml/min.) over 30 minutes, dried at the same temperature for 2 hours, and then cooled to room temperature to obtain a black solid. The resulting solid was heated from room temperature to 250° C. over 1 hour and 30 minutes under an air flow of 100 ml/min., dried at the same temperature for 3 hours and then air-cooled to room temperature to obtain 5.37 g of black supported ruthenium chloride catalyst on silica.

Incidentally, the calculated value of the content of ruthenium was as follows.

Ru/(RuCl₃.3H₂O+SiO₂)×100=4.5% by weight

The supported ruthenium chloride catalyst on silica (2.5 g) thus obtained was charged in a reaction tube in the same manner as that described in Example 2. According to the same manner as that described in Example 2 except for passing the hydrogen chloride gas (202 ml/min.) and the oxygen gas (213 ml/min.) and adjusting the inner temperature to 300° C., the reaction was conducted. 1.7 Hours after the beginning of the reaction, the formation activity of chlorine per unit weight of the catalyst was 0.49×10⁻⁴ mol/min·g-catalyst.

### COMPARATIVE EXAMPLE 2

A catalyst was prepared by the following process. That is, chromium nitrate enneahydrate (60.3 g) was dissolved in water (600 ml) and the solution was heated to 45° C. Then, 25 wt % ammonia water (64.9 g) was added dropwise over 1.5 hours with stirring, followed by stirring at the same temperature for additional 30 minutes. Water (3.3 liter) was added to the formed precipitate and, after standing overnight to cause sedimentation, the supernatant was removed by decantation. Then, water (2.7 liter) was added, followed by stirring sufficiently for 30 minutes. After the precipitate was washed by repeating this operation five times, the supernatant was removed by decantation. Then, 20 wt % silica sol (49 g) was added and, after stirring, the mixture was evaporated to dryness at 60° C. using a rotary evaporator. The resultant was dried at 60° C. for 8 hours and then dried at 120° C. for 6 hours to obtain a green solid. Then, this solid was calcined in air at 600° C. for 3 hours and then granulated by molding to obtain a Cr₂O₃—SiO₂ catalyst of 12 to 18.5 mesh.

The Cr₂O₃—SiO₂ catalyst (2.5 g) thus obtained was charged in a quartz reaction tube in the same manner as that described in Example 2 except that the Cr₂O₃—SiO₂ catalyst was not diluted with the titanium oxide carrier. According to the same manner as that described in Example 2 except for passing the hydrogen chloride gas (192 ml/min.) and adjusting the inner temperature to 301° C., the reaction was conducted. 3.7 Hours after the beginning of the reaction, the formation activity of chlorine per unit weight of the catalyst was 0.19×10⁻⁴ mol/min·g-catalyst.

### COMPARATIVE EXAMPLE 3

A catalyst was prepared by the following process. That is, a powder (8.0 g) prepared by grinding spherical titanium oxide (CS-300, manufactured by Sakai Chemical Industry Co., Ltd.) in a mortar and a ruthenium dioxide powder (manufactured by N.E. Chemcat Co., 0.53 g) were sufficiently mixed with grinding in a mortar, followed by adjusting to 12 to 18.5 mesh by molding to obtain a ruthenium oxide-titanium oxide mixed catalyst.

Incidentally, the calculated value of the content of ruthenium oxide was 6.2% by weight. The calculated value of the content of ruthenium was 4.7% by weight.

The ruthenium oxide-titanium oxide mixed catalyst (2.5 g) thus obtained was charged in a reaction tube in the same manner as that described in Example 2. According to the same manner as that described in Example 2 except for passing the hydrogen chloride gas (199 ml/min.) and the oxygen gas (194 ml/min.) and adjusting the inner temperature to 299° C., the reaction was conducted. 2.3 Hours after the beginning of the reaction, the formation activity of chlorine per unit weight of the catalyst was 0.83×10⁻⁴ mol/min·g-catalyst.

### COMPARATIVE EXAMPLE 4

A titania silica powder was obtained by the same manner as that described in Example 14.

The resulting titania silica powder (8.0 g) was impregnated with a solution prepared by dissolving a commercially available ruthenium chloride hydrate (RuCl₃.nH₂O, content of Ru: 35.5%) (1.13 g) in water(8.2 g), followed by drying in air at 60° C. for 1 hour to support ruthenium chloride. The supported one was heated from room temperature to 300° C. under a mixed flow of hydrogen (50 ml/min.) and nitrogen (100 ml/min.) over about 1 hour and 30 minutes, reduced at the same temperature for 1 hour and then cooled to room temperature to obtain a grayish blown supported metal ruthenium on titania silica(8.4 g).

The resulting supported metal ruthenium on titania silica (8.4 g) was heated from room temperature to 600° C. in an air flow (100 ml/min) over 3 hours and 20 minutes and then calcined at the same temperature for 3 hours to obtain a gray powder (8.5 g). A supported ruthenium oxide catalyst on titania silica was obtained by adjusting a particle size of the resulting powder to 12 to 18.5 mesh due to molding.

Incidentally, the calculated value of the content of ruthenium oxide was as follows.

RuO₂/(RuO₂+TiO₂+SiO₂)×100=6.2% by weight

The calculated value of the content of ruthenium was as follows.

Ru/(RuO₂+TiO₂+SiO₂)×100=4.2% by weight

The supported ruthenium oxide catalyst on titania silica (2.5 g) thus obtained was charged in a reaction tube in the same manner as that described in Example 2. According to the same reaction manner as that described in Example 2 except for passing the hydrogen chloride gas (180 ml/min.) and the oxygen gas (180 ml/min.) without diluting with the titanium oxide carrier, the reaction was conducted. 1.8 Hours after the beginning of the reaction, the formation activity of chlorine per unit weight of the catalyst was 0.46×10⁻⁴ mol/min·g-catalyst.

What is claimed is:

1. A process for producing chlorine which comprises oxidizing hydrogen chloride with oxygen by using a supported ruthenium oxide catalyst or a ruthenium mixed oxide type catalyst wherein a content of ruthenium oxide is from 0.1 to 20% by weight and a mean particle diameter of ruthenium oxide is from 1.0 to 10.0 nm.

2. A process according to claim 1, wherein the content of ruthenium oxide is from 1 to 15% by weight.

3. A process according to claim 1, wherein the mean particle diameter of ruthenium oxide is from 1.0 to 6.0 nm.

4. A process according to claim 1, wherein the supported ruthenium oxide catalyst is a catalyst supported on a carrier selected from the group consisting of titanium oxide, alumina, zirconium oxide, silica, titanium mixed oxide, zirconium mixed oxide, aluminum mixed oxide and silicon mixed oxide.

5. A process for producing chlorine which comprises oxidizing hydrogen chloride with oxygen by using a supported ruthenium oxide catalyst wherein a content of ruthenium oxide is from 0.5 to 20% by weight.

6. A process according to claim 5, wherein the content of ruthenium oxide is from 1 to 15% by weight.

7. A process according to claim 5, wherein the supported ruthenium oxide catalyst is a precipitation-supported ruthenium oxide catalyst.

8. A process according to claim 5, wherein the supported ruthenium oxide catalyst is a catalyst supported on a carrier selected from the group consisting of titanium oxide, alumina, zirconium oxide, silica, titanium mixed oxide, zirconium mixed oxide, aluminum mixed oxide and silicon mixed oxide.

9. A process for producing chlorine which comprises oxidizing hydrogen chloride with oxygen by using a supported ruthenium oxide catalyst obtained by oxidizing a supported metal ruthenium catalyst in a gas containing oxygen at not more than 500° C.

10. A process according to claim 9, wherein the oxidation treatment is conducted from 280° C. to 450° C.

11. A process according to claim 9, wherein the content of ruthenium oxide is from 1 to 15% by weight.

12. A process according to claim 9, wherein the supported ruthenium oxide catalyst is a catalyst supported on a carrier selected from the group consisting of titanium oxide, alumina, zirconium oxide, silica, titanium mixed oxide, zirconium mixed oxide, aluminum mixed oxide and silicon mixed oxide.

13. A process for producing chlorine which comprises oxidizing hydrogen chloride with oxygen by using a supported ruthenium oxide catalyst obtained by calcining a supported metal ruthenium catalyst in a gas containing oxygen in the presence of an alkali metal salt.

14. A process according to claim 13, wherein the alkali metal salt is selected from the group consisting of potassium chloride, sodium chloride and cesium nitrate.

15. A process according to claim 13, wherein the alkali metal salt is potassium chloride.

16. A process according to claim 13, wherein the calcination is performed at a temperature of 100° C. to 600° C.

17. A process according to claim 13, wherein the content of ruthenium oxide is from 0.5 to 15% by weight.

18. A process according to claim 13, wherein the supported ruthenium oxide catalyst is a catalyst supported on a carrier selected from the group consisting of titanium oxide, alumina, zirconium oxide, silica, titanium mixed oxide, zirconium mixed oxide, aluminum mixed oxide and silicon mixed oxide.

19. A process for producing chlorine which comprises oxidizing hydrogen chloride with oxygen by using a supported ruthenium oxide catalyst obtained by supporting with a spherical carrier having a particle size of 10 to 500 μm.

20. A process for producing chlorine which comprises oxidizing hydrogen chloride with oxygen by using a catalyst obtained by coating an inert carrier with a ruthenium oxide catalyst, or a catalyst obtained by extruding a ruthenium oxide catalyst.

21. A process for producing chlorine which comprises oxidizing hydrogen chloride with oxygen by using a ruthenium catalyst in an aqueous phase.
